(19) United States
(12) Patent Application Publication
(10) Pub. No.: US 2007/0289604 A1
(43) Pub. Date: Dec. 20, 2007

(54) Substrate Processing Apparatus

(76) Inventors: Yukio Fukunaga, Tokyo (JP); Akira Susaki, Tokyo (JP); Junji Kunisawa, Tokyo (JP); Hiroyuki Ueyama, Tokyo (JP); Shohei Shima, Tokyo (JP); Akira Fukunaga, Tokyo (JP); Hideki Tateishi, Tokyo (JP); Junko Mine, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/587,974

(22) PCT Filed: Apr. 27, 2005
(86) PCT No.: PCT/JP05/08061

§ 371 Date: Jul. 17, 2007

(30) Foreign Application Priority Data
Apr. 30, 2004 (JP) 2004-135655
May 7, 2004 (JP) 2004-139252

(51) Int. Cl. C23G 1/02; B08B 3/00; G05D 23/00; G05D 99/00

(52) U.S. Cl. 134/3; 134/105; 700/299; 700/306

(57) ABSTRACT

To provide an apparatus and a method capable of supplying a gas containing an evaporated reducing organic compound while strictly controlling the flow rate thereof to process a surface of a metal on a substrate without causing any deterioration of various types of films forming a semiconductor element with a simple apparatus configuration.

The apparatus includes a process chamber 10 for keeping a substrate W therein, the process chamber 10 being gastight, an evacuation control system 20 for controlling the pressure in the process chamber 10, and a process gas supply system 30 for supplying a process gas containing a reducing organic compound to the process chamber 10. The process gas supply system 30 has an evaporator 32 keeping liquid material of the reducing organic compound therein and having an evaporating liquid surface S, a process gas pipe 18 for directing the process gas containing the reducing organic compound evaporated in the evaporator 32 into the process chamber 10, and a throttle element 40 disposed in the process gas pipe 18 for controlling the flow rate of the process gas to be supplied to the process chamber 10 by adjusting the opening of the throttle element 40. The opening of the throttle element 40 is so set that the pressure variation in the evaporator 32 can be maintained within a prescribed range.

### TECHNICAL FIELD

The present invention relates to a substrate surface processing method and apparatus for cleaning a surface of a semiconductor substrate in, for example, the process of manufacturing a semiconductor device. The present invention also relates to a substrate processing apparatus for removing an oxide film on a surface of a metal on a semiconductor substrate in, for example, the process of manufacturing a semiconductor device.

### BACKGROUND ART

In the process of manufacturing a semiconductor device, various processes are performed on a surface of a semiconductor substrate. With improvement of the degree of integration, the importance of a washing process or surface processing processes such as removal of an oxide film is increasing more and more. This is because, in the step of depositing a metal vertically on a wiring surface to provide electrical communication using a conductive metal such as copper between wiring layers, for example, when an oxide film exists on a surface of the lower metal layer, the oxide film intervenes at the interface between the metals and the intervention of an oxide film at the interface, which did not cause any problem at a conventional integration density, appears as a defect of communication failure with further miniaturization of wiring due to high-density integration.

A wet process using a chemical solution, which has been prevailing as a conventional washing method, is now almost replaced by dry processes for reasons such as because the wet process damages microstructured devices themselves and because it imposes a heavy load on the environment although having a good washing effect. Among the dry processes, a sputtering method in which energy particles are forced to collide with a surface in a vacuum may also destroy the surface, or may damage an insulating film because of the high processing temperature. Therefore, the use of a chemically active organic acid or reducing gas is proposed.

For example, JP-A-Hei 11-233934 discloses a method using a carboxylic acid tank connected via a valve to supply gas to a process chamber. In this method, however, since the amount of evaporation (amount of supply) of carboxylic acid is determined by the pressure in the chamber, strict control of the supply amount in such microfabrication as semiconductor manufacturing is difficult.

Also, JP-A-2003-218198 discloses a method in which a carboxylic acid solution is supplied from a storage tank to a carburetor while measuring it with a mass flow controller and evaporated in the carburetor, and the evaporated gas is mixed with a carrier gas and introduced into a chamber. This method is suitable for microfabrication of semiconductor and so on from the viewpoint of supplying a constant amount of carboxylic acid gas. However, each of a storage tank and a carburetor is required, and the system is mechanically very complex.

Also, JP-A-Hei 11-87353, for example, discloses a method for removing a natural oxide film including a step of forming copper wiring and a step of heating in a reducing gas at a temperature in the range of 250° C. to 450° C. However, microscopic elements formed on a substrate are likely to be affected by temperature. Therefore, also in this method of the related art, the elements may be damaged or deteriorated because of the high processing temperature.

### DISCLOSURE OF INVENTION

### Problem to be Solved by the Invention

The present invention has been made in view of the above circumstances, and it is, therefore, an object of the present invention to provide an apparatus and a method capable of supplying a process gas containing a reducing organic compound such as carboxylic acid while strictly controlling the flow rate of the process gas despite of a simple apparatus configuration. Another object of the present invention is to provide an apparatus with a simple apparatus configuration capable of processing a surface of a metal on a substrate without deteriorating various types of films forming a semiconductor element.

### Means for Solving the Problem

To achieve the above object, a substrate processing apparatus according to the present invention comprises, as shown in FIG. 1, for example, a process chamber 10 for keeping a substrate W therein, the process chamber 10 being gastight; an evacuation control system 20 for controlling the pressure in the process chamber 10; and a process gas supply system 30 for supplying a process gas containing a reducing organic compound to the process chamber 10; the process gas supply system 30 having an evaporator 32 keeping liquid material of the reducing organic compound therein and having an evaporating liquid surface S; a process gas pipe 18 for directing the process gas containing the reducing organic compound evaporated in the evaporator 32 into the process chamber 10; and a throttle element 40 disposed in the process gas pipe 18 for controlling the flow rate of the process gas to be supplied to the process chamber 10 by adjusting the opening of the throttle element 40; wherein the opening of the throttle element 40 is so set that the pressure variation in the evaporator 32 can be maintained within a prescribed range.

Alternatively, the present invention may be a substrate surface processing apparatus comprising a gastight process chamber for keeping a substrate; an evacuation control system for controlling the gas pressure in the process chamber; and a process gas supply system for supplying a process gas containing a reducing organic compound to the process chamber; wherein the process gas supply system having an evaporator for keeping a reducing organic compound material in a liquid form such that the material has an evaporating liquid surface which is sufficiently large with respect to the supply rate of the process gas to be supplied to the process chamber; a process gas pipe for directing the process gas evaporated in the evaporator into the process chamber; and a throttle element disposed in an intermediate portion of the process gas pipe for supply rate control, in which the opening of the throttle element is so set that even when the pressure in the process chamber varies, the variations in the pressure in the evaporator can be maintained within a prescribed range.

In the present invention, the liquid material of the reducing organic compound is evaporated in an evaporator which provides an evaporating liquid surface which is sufficiently large with respect to the supply rate of the process gas to be supplied to the process chamber and directed into the process chamber via a throttle element. By setting the opening of the throttle element, the variations in the pressure in the evaporator can be maintained within a prescribed range even when the pressure in the process chamber varies. Also, since the throttle element is disposed in the process gas pipe, an adequate amount of evaporated reducing organic compound material can be directed to the process chamber without using a carrier gas. In addition, the evaporating liquid surface has an evaporation area which is large enough to generate the supply rate of process gas to be supplied to the process chamber, which is expressed as an evaporating liquid surface which is sufficiently large. Also, the opening is the area through which the process gas passes, and, when the throttle element is an orifice or a capillary tube, determining its opening to a prescribed diameter is included in the concept of adjusting the opening.

In the substrate processing apparatus 101 (102, 105, 106) according to the present invention, as shown in FIG. 1 (FIG. 3, FIG. 7, FIG. 8), for example, the process gas supply system 30 may control the pressure in the evaporator 32 at 80 to 100% of the saturated vapor pressure of the reducing organic compound in the environment in the evaporator 32.

In this configuration, the pressure in the evaporator is controlled at 80 to 100% of the saturated vapor pressure of the reducing organic compound in the environment in the evaporator, and pressure variations in the evaporator can be easily suppressed. The “to” in value ranges means “not lower than” and “not higher than” (the values specified are included). The same applies hereinafter.

In the substrate processing apparatus 101 (102, 105, 106) according to the present invention, as shown in FIG. 1 (FIG. 3, FIG. 7, FIG. 8), for example, the throttle element may be at least one of a mass flow controller, an orifice, a capillary tube, and a throttle valve.

In this configuration, when a mass flow controller is used, a passing flow rate can be set and the reducing organic compound gas can be supplied stably with high accuracy. When an orifice, capillary tube, throttle valve or the like is used, very inexpensive and simple flow rate control can be achieved when the gas flow rate is corrected based on the temperature in the evaporator and the pressure in the process chamber.

The substrate processing apparatus 102 according to the present invention may comprise, as shown in FIG. 3, for example, a heating means 37 for controlling the evaporator 32 at a prescribed evaporation temperature. Here, the evaporation temperature is a temperature corresponding to a prescribed saturated pressure of the reducing organic compound. The prescribed saturated pressure is typically a pressure at which the flow rate of reducing organic compound in a gas form necessary to process the substrate can be obtained from the reducing organic compound in a liquid form. Also, the prescribed pressure is typically a pressure which is equal to or higher than the total pressure of the pressure in the process chamber, a differential pressure required in the throttle element, pressure losses in other flow paths and so on.

In this configuration, the temperature in the evaporator is controlled at the evaporation temperature of the process gas component, and the apparatus can be used with the saturated vapor pressure raised and the gas supply rate increased.

In the substrate processing apparatus 101 (102, 105, 106) according to the present invention, the evaporation temperature may be generally equal to room temperature.

In such a case, the evaporation temperature is set to remain generally at room temperature. In general, since a process of processing a surface of a semiconductor substrate is carried out in a clean room maintained at a temperature of approximately 23 to 25° C., the evaporation temperature is maintained generally constant. Therefore, the apparatus configuration is very simple, and the apparatus cost can be reduced. The term “generally” means that a range of variations of a temperature set in the clean room is included.

The substrate processing apparatus 102 (105, 106) according to the present invention may comprise, as shown in FIG. 3(FIG. 7, FIG. 8), for example, a heating means 41 (19) for heating the process gas pipe 18 to a temperature which is equal to or higher than a temperature in the evaporator 32.

In this configuration, the process gas pipe is heated to a temperature equal to or higher than the temperature in the evaporator, condensation of the process gas in this section, can be prevented, and stable gas supply is further ensured.

The substrate processing apparatus 105, 106 according to the present invention may comprise, as shown in FIG. 7 and FIG. 8, for example, a heating means 19 for heating a secondary side section including the throttle element in the process gas pipe to a temperature which is equal to or higher than the evaporation temperature.

In this configuration, a secondary side section including the throttle element in the process gas pipe is heated to a temperature equal to or higher than the temperature in the evaporator, and the process gas can be prevented from being condensed in this section and can be supplied stably.

In the substrate processing apparatus 101 (102, 105, 106) according to the present invention, the reducing organic compound may be a carboxylic acid.

In this configuration, a surface of the metal is processed by the moderate reactivity of the carboxylic acid. Among carboxylic acids, formic acid, especially, has an effect of reducing an oxide film on, for example, a surface of copper.

In the substrate processing apparatus 101 (102, 105, 106) according to the present invention, the reducing organic compound may be methanol or ethanol. Alcohols are easy to handle since they have less toxicity to human bodies than carboxylic acids and exhibits very low corrosive effects on structural materials.

In the substrate processing apparatus 101 (102, 105, 106) according to the present invention, the reducing organic compound may be formaldehyde or acetaldehyde.

In the substrate processing apparatus 106 according to the present invention, as shown in FIG. 8, for example, the process chamber 10 may be connected to a vacuum transportation system 93 for transporting the substrate W in a gastight condition.

It is possible to avoid opening to the atmosphere when the substrate is put in or taken out, and to prevent the substrate from being exposed to the atmosphere while the temperature of the substrate is still high. Thus, re-oxidation of the substrate surface can be prevented. Especially, a copper wiring material easily forms an oxide film on its surface when exposed to an oxidative atmosphere at a high temperature. This can be prevented.

In the substrate processing apparatus 106 according to the present invention, as shown in FIG. 8, for example, the process chamber 10 may be at least one of constituent elements of a composite processing apparatus including the vacuum transportation system 93. The composite processing apparatus is an apparatus having a plurality of clustered process chambers arranged around a vacuum transportation chamber so that a plurality of types of processing can be performed on an object to be processed without exposing it to the atmosphere. For example, when it is used for preprocessing prior to a film formation step using a sputtering device or a CVD device, re-oxidation in the period until the next step after the surface processing for removing an oxide film as described before can be prevented.

In the substrate processing apparatus according to the present invention, as shown in FIG. 4 (FIG. 5), for example, the throttle element 80 (80A) may be secured to a part of the process chamber 60 so that the throttle element 80 (80A) can be heated by the process chamber 60. Then, the section including the throttle element in the process gas pipe is heated to a temperature equal to or higher than the temperature in the evaporator using the process chamber as a heat source, the process gas can be prevented from being condensed in this section and can be supplied stably.

In the substrate processing apparatus 101 (102, 105, 106) according to the present invention, as shown in FIG. 1(FIG. 3, FIG. 7, FIG. 8), for example, the ratio between the evaporation area in the evaporator 32 and the area to be processed of the substrate W may be at least 0.031. By setting as described above, a constant flow rate of the gas required for the processing can be stably supplied. Here, the area to be processed of the substrate is the area of a surface (typically, upper surface) of the substrate on which wiring has been formed, and the ratio of the area to be processed is a value obtained by dividing the evaporation area by the area to be processed of the substrate.

The substrate processing apparatus 106 according to the present invention may comprise, as shown in FIG. 8, for example, a substrate stage 12 provided in the process chamber 10 for placing the substrate W thereon and heating the substrate W; a process gas supply port 16 located at a position facing the substrate stage 12 for supplying the process gas toward the substrate W; and a control device 99 for performing control to raise the temperature of the substrate W to a first prescribed temperature and supply the process gas to the substrate W to remove an oxide on a surface of a metal on the substrate W with the evaporated reducing organic compound material, and to hold the substrate W in the process chamber 10 and maintain the substrate W at the first prescribed temperature for a first prescribed period of time after stopping the supply of the process gas.

In this configuration, after removing the oxide on a surface of a metal on the substrate with the evaporated reducing organic compound material, the substrate can be kept in the process chamber and maintained at a first prescribed temperature to remove the compound scattered by etching.

To achieve the above object, a substrate processing method according to the present invention comprises the steps of, as shown in FIG. 1 (FIG. 3, FIG. 7, FIG. 8), for example, evaporating a reducing organic compound material in a liquid form to generate a process gas containing the reducing organic compound material; adjusting the flow rate of the process gas by allowing the process gas to pass through a throttle element 40; and supplying the process gas after the flow rate adjustment to the substrate W; wherein the flow rate of the process gas to be supplied to the substrate W is so set that the pressure variation of the vapor of the reducing organic compound material before passing through the throttle element 40 can be maintained within a prescribed range. In this configuration, the flow rate of the process gas to be supplied to the substrate can be appropriate.

A substrate processing method according to the present invention may be a method for processing a surface of a substrate kept in a gastight process chamber with a process gas containing a reducing organic compound, in which a reducing organic compound material in a liquid form is contained in an evaporator which provides an evaporating liquid surface which is sufficiently large with respect to the supply rate of process gas to be supplied to the process chamber, the process gas evaporated in the evaporator is directed into the process chamber via a throttle element for supply rate control, and the opening of the throttle element is so set that even when the pressure in the process chamber varies, the variations in pressure in the evaporator can be maintained within a prescribed range.

The substrate processing method according to the present invention may comprise the step of, removing an oxide generated on a metal portion on a surface of the substrate W by carrying out reduction and etching of the oxide with the process gas supplied to the substrate W.

To achieve the above object, a substrate processing apparatus according to the present invention comprises, as shown in FIG. 1 (FIG. 3, FIG. 7, FIG. 8), for example, a process chamber 10 for keeping a substrate W therein, the process chamber 10 being gastight; a substrate stage 12 provided in the process chamber 10 for placing the substrate W thereon and heating the substrate W; a process gas supply port 16 located at a position facing the substrate stage 12 for supplying a process gas containing an evaporated reducing organic compound material toward the substrate W; an evacuation control means 20 for evacuating gas in the process chamber 10 to bring the pressure in the process chamber 10 to a prescribed level; and a process gas introduction means 30 for introducing the process gas into the process chamber 10 while controlling the flow rate of the process gas, wherein the temperature of the substrate W is controlled at 140 to 250° C. so that an oxide on a surface of a metal on the substrate W can be removed with the evaporated reducing organic compound material. Then, the processing can be carried out while preventing deterioration of a substrate to be processed such as a semiconductor wafer which is sensitive to temperature. Examples of the process gas supply port include a shower head having a plurality of holes through which a process gas is supplied to the substrate, a nozzle having one hole, and a nozzle which has a plurality of holes but cannot be called shower head under normal social conventions. The shape and the number of the holes of the process gas supply port are not specifically limited as long as the process gas can be diffused and supplied uniformly and cover the part to be processed of the substrate to be processed in relation to the discharge rate and the flow speed of the process gas.

In the substrate processing apparatus 101 (102, 105, 106) according to the present invention, as shown in FIG. 1 (FIG. 3, FIG. 7, FIG. 8), for example, the temperature of the substrate W may be controlled at 160 to 210° C. The temperature of the substrate may be controlled more preferably at 175 to 200° C., much more preferably at 180 to 195° C. Then, the processing can be carried out while sufficiently preventing deterioration of a substrate to be processed such as a semiconductor wafer which is sensitive to temperature.

In the substrate processing apparatus according to the present invention, the process gas may have a pressure of 40 Pa or higher. Then, a processing rate which is high enough for practical use can be achieved under a low temperature condition of 250° C. or lower, which has not yet been into practical use.

In the substrate processing apparatus according to the present invention, the process gas may have a pressure of 400 Pa or higher. Then, a processing rate which is high enough for practical use can be achieved under a low temperature condition of 200° C. or lower, which has not yet been into practical use.

In the substrate processing apparatus according to the present invention, when the process gas has a pressure in the range of 40 Pa or higher, the oxide on the surface of the metal on the substrate may be removed under the condition that T and Y are in a range greater than T and Y represented by the following equation:
Y=(1.23×10⁵×exp(−0.0452T)+3634×exp(−0.0358T))/40
wherein T (° C.) represents the temperature of the substrate at which the oxide is removed, and Y (minutes/nm) represents the processing time in which the oxide with a unit thickness is removed. Then, minimum processing time necessary to remove an oxide to a practically appropriate degree under a low temperature condition can be set to achieve high processing efficiency.

In the substrate processing apparatus according to the present invention, when the process gas has a pressure in the range of 400 Pa or higher, the oxide on the surface of the metal on the substrate may be removed under the condition that T and Y are in a range greater than T and Y represented by the following equation:
Y=(202×exp(−0.0212T)+205×exp(−0.0229T))/40
wherein T (° C.) represents the temperature of the substrate at which the oxide is removed, and Y (minutes/nm) represents the processing time in which the oxide with a unit thickness is removed. Then, minimum processing time necessary to remove an oxide to a practically appropriate degree under a lower temperature condition can be set to achieve high processing efficiency.

The oxide on a surface of a metal on the substrate is typically an oxide film formed by oxidation of the surface of the metal. The oxide film herein is a concept which includes a natural oxide film and a forced oxide film. Here, the natural oxide film refers to an oxide film which is generated on a surface of a metal formed on a substrate when an object is placed in a storage atmosphere (the atmosphere in a clean room in semiconductor manufacturing, for example) at room temperature without intentionally heating the substrate or exposing it to an oxidative atmosphere, and typically has a thickness of approximately 1 to 2 nm. On the other hand, the forced oxide film refers to an oxide film which is generated on a surface of a metal formed on a substrate by intentionally heating the substrate and/or exposing it to an oxidative atmosphere. A forced oxide film has a thickness greater than that of a natural oxide film, which is at least a few nm and typically at least 10 nm. The thickness can be adjusted depending on the heating and/or oxidative atmosphere conditions.

In the substrate processing apparatus according to the present invention, when the process gas has a pressure in the range of 130 Pa or higher, a natural oxide film generated on the surface of the metal on the substrate may be removed under the condition that T and Y are in a range greater than T and Y represented by the following equation:
Y=0.76×10⁵×exp(−0.0685T)
wherein T (° C.) represents the temperature of the substrate at which the natural oxide film is removed, and Y (minutes/nm) represents the processing time in which the natural oxide film with a unit thickness is removed. Then, minimum processing time necessary to remove a natural oxide film to a practically appropriate degree under a lower temperature condition can be set to achieve high processing efficiency.

In the substrate processing apparatus according to the present invention, when the process gas has a pressure in the range of 400 Pa or higher, a natural oxide film generated on the surface of the metal on the substrate may be removed under the condition that T and Y are in a range greater than T and Y represented by the following equation:
Y=1.32×10⁵×exp(−0.0739T)
wherein T (° C.) represents the temperature of the substrate at which the natural oxide film is removed, and Y (minutes/nm) represents the processing time in which the natural oxide film with a unit thickness is removed. Then, minimum processing time necessary to remove a natural oxide film to a practically appropriate degree under a lower temperature condition can be set to achieve high processing efficiency.

In the substrate processing apparatus according to the present invention, the substrate may be a wafer for semiconductor. Then, processing can be carried out while preventing deterioration of various types of elements and films as constituents thereof formed on a semiconductor wafer.

In the substrate processing apparatus according to the present invention, the metal on the substrate may be copper. Then, an oxide film on a copper film can be removed and electrical communication can be ensured when a metal is deposited to form wiring thereon by, for example, a damascene step.

In the substrate processing apparatus according to the present invention the reducing organic compound material may be formic acid. Formic acid has an effect of reducing an oxide film on a surface of, for example, copper.

To achieve the above object, a substrate processing method according to the present invention comprises the steps of, as shown in FIG. 1 (FIG. 3, FIG. 7, FIG. 8), for example, removing an oxide generated on a metal portion on a surface of a substrate W by heating the substrate W kept in a process chamber 10 to a first prescribed temperature and supplying an evaporated reducing organic compound material to the substrate W; and maintaining the substrate W at the first prescribed temperature for a first prescribed period of time while holding the substrate W in the process chamber 10 after stopping the supply of the evaporated reducing organic compound material. In this configuration, it is possible to remove the compound scattered by etching while maintaining the substrate at the first prescribed temperature.

In the substrate processing method according to the present invention, the first prescribed period of time may be at least 3 seconds. In this configuration, the compound scattered by etching can be removed and it is easy to confirm that the substrate has been maintained at the first prescribed temperature.

The substrate processing method according to the present invention may comprise the steps of, as shown in FIG. 1(FIG. 3, FIG. 7, FIG. 8), for example, removing an oxide generated on a metal portion on a surface of a substrate W by heating the substrate W kept in a process chamber 10 to a first prescribed temperature and supplying an evaporated reducing organic compound material to the substrate W; and lowering gradually the temperature of the substrate W from the first prescribed temperature over a second prescribed period of time while holding the substrate W in the process chamber 10 after stopping the supply of the evaporated reducing organic compound material. In this configuration, when the substrate is cooled after removing the compound scattered by etching, thermal shock in the substrate can be suppressed.

In the substrate processing method according to the present invention, the second prescribed period of time may be 5 seconds or longer and 10 minutes or shorter. In this configuration, thermal shock in the substrate can be suppressed more reliably.

The substrate processing method according to the present invention may comprise the steps of, as shown in FIG. 1 (FIG. 3, FIG. 7, FIG. 8), for example, removing an oxide generated on a metal portion on a surface of a substrate W by heating the substrate W kept in a process chamber 10 to a first prescribed temperature and supplying an evaporated reducing organic compound material to the substrate W; and raising the temperature of the substrate W to a second prescribed temperature which is higher than the first prescribed temperature while holding the substrate W in the process chamber 10 after stopping the supply of the evaporated reducing organic compound material. In this configuration, when the compound scattered by etching is removed, separation of the compound from the substrate surface can be promoted and the removal of the compound can be completed in a short period of time. Also, compounds which can be separated from the substrate surface at a high temperature can be removed.

The substrate processing method according to the present invention may comprise the step of, as shown in FIG. 1 (FIG. 3, FIG. 7, FIG. 8), for example, evacuating the evaporated reducing organic compound material from the process chamber 10 to raise the degree of vacuum in the process chamber 10 after stopping the supply of the evaporated reducing organic compound material, wherein the step of raising the degree of vacuum in the process chamber 10 and the step of controlling the temperature of the substrate after stopping the supply of the evaporated reducing organic compound material are performed in parallel. In this configuration, since the pressure is lowered while continuing heating, collisions of molecules in a vapor phase decrease. Therefore, separation of the compound from the substrate is promoted and re-adhesion of the compound can be prevented as a whole.

The substrate processing method according to the present invention may comprise the steps of, as shown in FIG. 8, for example, bringing the temperature of the substrate W to a next step temperature as a temperature for a next step which is carried out in another process chamber 93 other than the process chamber 10; and transporting the substrate W having reached the next step temperature into the another process chamber 93. In this configuration, transition to the next step can be done smoothly.

A control program which controls the substrate processing apparatus in which the substrate processing method according to the present invention is used may be installed in the computer connected to the substrate processing apparatus, then the computer controls the substrate processing apparatus. In this configuration, a sequence for causing the substrate processing apparatus to operate to remove the compound scattered by etching can be achieved.

The substrate processing apparatus according to the present invention may comprise, as shown in FIG. 8, for example, an process chamber 10 for keeping a substrate W thereon, the process chamber 10 being gastight; and a control device 99 including a computer in which the control program as above is installed. In this configuration, a substrate processing apparatus capable of removing a compound scattered by etching can be provided.

In accomplishing the objects described before, a substrate processing apparatus according to the present invention may have: a process chamber 10 for keeping a substrate W; and a reducing organic compound supply means 30 for supplying an evaporated reducing organic compound to the substrate W, and may be configured to remove an oxide generated on a metal portion on a surface of the substrate W with the evaporated reducing organic compound as shown in FIG. 1 (FIG. 3, FIG. 7, and FIG. 8), for example. In this configuration, since the oxide generated on a metal portion on a surface of the substrate is removed with the evaporated reducing organic compound, there is no need to use a wet process or a sputtering method and the oxide film can be removed without damaging the substrate.

This application is based on the Patent Applications No. 2004-135655 filed on Apr. 30, 2004 and 2004-139252 filed on May 7, 2004 in Japan, the contents of which are hereby incorporated in its entirety by reference into the present application, as part thereof.

The present invention will become more fully understood from the detailed description given hereinbelow. However, the detailed description and the specific embodiment are illustrated of desired embodiments of the present invention and are described only for the purpose of explanation. Various changes and modifications will be apparent to those ordinary skilled in the art on the basis of the detailed description.

The applicant has no intention to give to public any disclosed embodiment. Among the disclosed changes and modifications, those which may not literally fall within the scope of the patent claims constitute, therefore, a part of the present invention in the sense of doctrine of equivalents.

The use of the terms “a” and “an” and “the” and similar referents in the context of describing the invention (especially in the context of the following claims) are to be construed to cover both the singular and the plural, unless otherwise indicated herein or clearly contradicted by context. The use of any and all examples, or exemplary language (e.g., “such as”) provided herein, is intended merely to better illuminate the invention and does not pose a limitation on the scope of the invention unless otherwise claimed.

### EFFECT OF THE INVENTION

According to the present invention, when a throttle element is provided in the process gas pipe, the pressure of the reducing organic compound gas on the primary side of the throttle element can be maintained at a constant pressure which is equal to or higher than a prescribed value at least during the processing of the substrate even if the pressure in the process chamber varies slightly. Therefore, gasification of the reducing compound and supply of a constant amount of the reducing compound can be carried out stably. As a result, uniform and continuous gas supply onto the substrate can be realized, and surface processing on the substrate can be carried out uniformly.

Also, according to the present invention, when the temperature of the substrate is controlled at 140 to 250° C. and the oxide on a surface of a metal on the substrate is removed with an evaporated reducing organic compound material, the processing can be carried out while preventing deterioration of a substrate to be processed which is sensitive to temperature such as a semiconductor wafer. That is, when the process gas pressure is set to a prescribed value, the processing can be carried out even at a low temperature, and practical temperature/pressure conditions can be selected in relation to the processing time.

In addition, according to the present invention, when the substrate is held in the process chamber and maintained at the first prescribed temperature after removing the oxide on a surface of a metal on the substrate with an evaporated reducing organic compound material, the compound scattered by etching can be removed.

### BRIEF DESCRIPTION OF DRAWINGS

FIG. 1 is a view illustrating the general configuration of a substrate processing apparatus according to a first embodiment of the present invention.

FIG. 2 is a view illustrating the general configuration of a modification of a process gas supply port of the substrate processing apparatus.

FIG. 3 is a view illustrating the general configuration of a substrate processing apparatus according to a second embodiment of the present invention.

FIG. 4 is a view illustrating the general configuration of a substrate processing apparatus according to a third embodiment of the present invention.

FIG. 5 is a view illustrating the general configuration of a substrate processing apparatus according to a fourth embodiment of the present invention.

FIG. 6 is a graph showing the relation between the formic acid gas flow rate and the pressure in the evaporator in the apparatus according to the first embodiment of the present invention.

FIG. 7 is a view illustrating the general configuration of a substrate processing apparatus according to a fifth embodiment of the present invention.

FIG. 8 is a view illustrating the general configuration of a substrate processing apparatus according to a sixth embodiment of the present invention.

FIG. 9 is a graph showing a result in a seventh embodiment of the present invention.

FIG. 10 is a graph showing a result in an eighth embodiment of the present invention.

FIG. 11 is a graph showing a result in a ninth embodiment of the present invention.

FIG. 12 is a graph illustrating the progress of the removal of a natural oxide film in the case where a process gas supply port of the substrate processing apparatus is a shower head.

FIG. 13 is a graph illustrating the progress of the removal of a natural oxide film in the case where a process gas supply port of the substrate processing apparatus is a single-hole nozzle.

FIG. 14 is a graph showing the amount of copper atoms scattered during an oxide film removing processing.

FIG. 15 is a time chart for explaining a substrate processing method according to a tenth embodiment of the present invention.

FIG. 16 is a time chart for explaining a substrate processing method according to an eleventh embodiment of the present invention.

FIG. 17 is a time chart for explaining a substrate processing method according to a twelfth embodiment of the present invention.

FIG. 18 is a time chart for explaining a substrate processing method according to a thirteenth embodiment of the present invention.

FIG. 19 is a time chart for explaining a substrate processing method according to a fourteenth embodiment of the present invention.

### DESCRIPTION OF REFERENCE NUMERALS AND SYMBOLS

10: process chamber
12: substrate stage
16: process gas supply port
18: process gas pipe
19, 41: heating means
20: evacuation control system
30: process gas supply system
32: evaporator
37: heating means
40: throttle element
60: process chamber
80 (80A): throttle element
93: another process chamber (vacuum transportation system)
99: control device
101, 102, 105, 106: substrate processing apparatus
S: evaporating liquid surface
W: substrate

### BEST MODE FOR CARRYING OUT THE INVENTION

Description is hereinafter made of embodiments of the present invention with reference to the drawings. The same or corresponding devices, components and so on are denoted in all the drawings with the same or similar reference numerals, and redundant description is omitted.

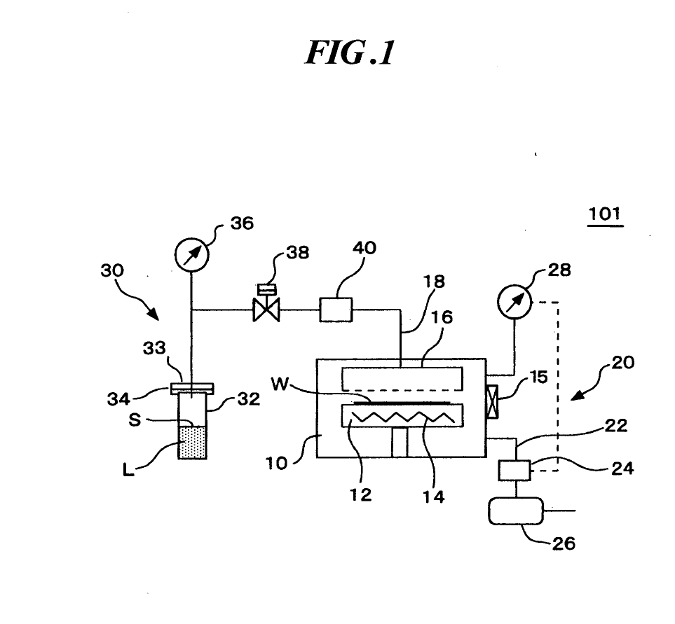

FIG. 1 illustrates a substrate surface processing apparatus according to a first embodiment of the present invention. A process chamber 10 is made of a material having corrosion resistance against processing chemicals or substances generated by a processing reaction or a member subjected to surface processing for corrosion resistance, and defines therein a gastight cylindrical space. A substrate stage 12 for supporting thereon a substrate W to be processed is located at a lower central position in the process chamber 10. The substrate stage 12 is provided therein a heater 14 for heating the substrate W at a prescribed temperature, and, as needed, a temperature sensor and so on. A shower head (gas diffusing porous plate) 16 as a process gas supply port is provided above the substrate stage 12. The shower head 16 is connected to a process gas pipe 18 inserted into the process chamber 10 from above, and supplies a reducing organic compound gas while uniformly diffusing onto a surface to be processed of the substrate W on the substrate stage 12.

The process chamber 10 is provided with an evacuation control system 20 for evacuating the process chamber 10 and controlling the pressure therein. The evacuation control system 20 has a pressure adjusting valve 24 and a vacuum evacuation pump 26 provided in an evacuation pipe 22, and a chamber vacuum gauge 28 for measuring the pressure in the process chamber 10. The gas pressure in the process chamber 10 is detected by the chamber vacuum gauge 28, and, based on an output therefrom, the pressure adjusting valve 24 is controlled to maintain the inside of the process chamber 10 at a prescribed pressure. The process chamber 10 is provided with a gate valve 15 which can be opened and closed to put in or take out the substrate W, and, as needed, with a well-known slow evacuation line or purging gas supply line.

A process gas supply system 30 for supplying a process gas containing a reducing organic compound to the process chamber 10 is provided. The process gas supply system 30 has a circular cylindrical evaporator 32 made of a stainless having corrosion resistance or fused silica (glass). An openable lid 33 is attached to an upper part of the evaporator 32 via a sealing part 34. The evaporator 32 contains a reducing organic compound material L, and the area of the liquid surface S thereof, that is, the cross-sectional area of the evaporator 32, is set to such a size that can sufficiently supply the amount of process gas required in the process chamber 10, including variations.

The process gas pipe 18, through which evaporated reducing organic compound gas is discharged to the process chamber 10, is inserted through the openable lid 33 with its end opening above the liquid surface. The process gas pipe 18 is communicated with the shower head 16 in the process chamber 10 via an on-off valve 38 for starting or stopping the supply of the gas and a mass flow controller 40 as a throttle element. To detect the gas pressure in the evaporator 32, a gas source vacuum gauge 36 is provided branching from the process gas pipe 18.

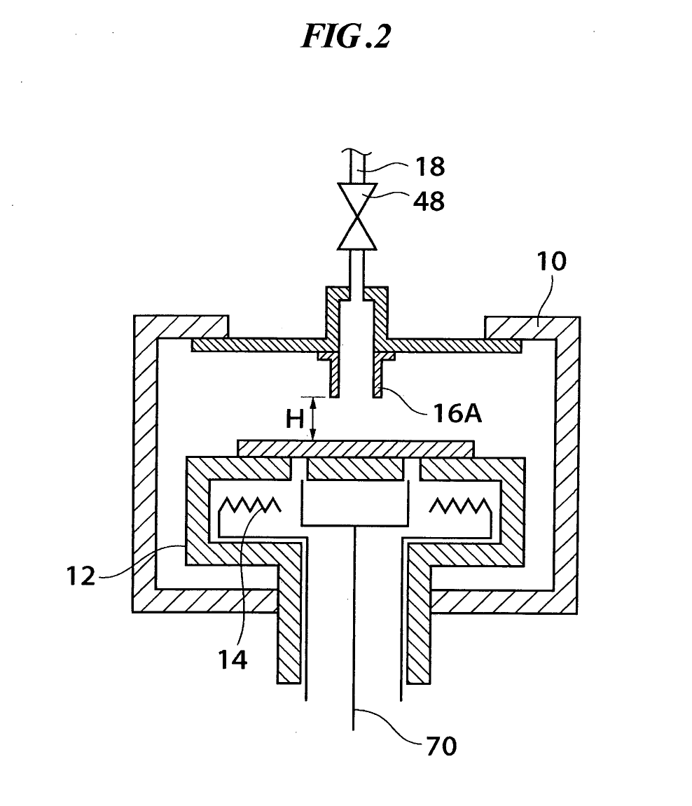

Referring now to FIG. 2, a modification of the process gas supply port of the substrate processing apparatus is described. In the modification shown in FIG. 2, a nozzle 16A is provided in place of the shower head 16. The nozzle 16A has an end located in the process chamber 10 and is connected to the process gas pipe 18. The nozzle 16A is located generally vertically above the center of the substrate W or generally vertically above the center of the substrate stage 12, and the end of the nozzle 16A and the substrate W are apart from each other by a distance H. Although the nozzle 16A typically has one opening, it may have a plurality of openings.

The process of removing an oxide film on a surface of fine copper wiring formed on a semiconductor wafer (substrate) W by a damascene method with the substrate surface processing apparatus constituted as described above is described. For example, the process is conducted, in ULSI production, to process the surfaces of the bottoms of wiring connection holes (via holes) in the depth direction of the substrate W opening in an interlayer insulation film in a multi-layered wiring structure prior to filling copper into the wiring connection holes.

First, the vacuum evacuation pump 26 and so on of the evacuation control system 20 are started, and, as needed, a leakage gas such as N₂ or Ar is supplied to adjust the space in the process chamber 10 to a prescribed pressure. The substrate stage 12 has been heated at a prescribed temperature in advance with the heater 14. Then, the gate valve 15 is opened, and a semiconductor wafer W is put in the process chamber 10 with a robot arm or the like from an auxiliary chamber (not shown) in which the pressure has been adjusted to generally the same as that in the process chamber 10 in advance. The semiconductor wafer W is heated to a prescribed temperature placed on the substrate stage 12. After that, the introduction of the leakage gas is stopped, and the on-off valve 38 is opened to supply the process gas to the process chamber 10 to start the surface processing.

The opening of the pressure adjusting valve 24 is controlled based on the value monitored by the chamber vacuum gauge 28 to control the pressure in the process chamber 10 at a prescribed value. The pressure in the process chamber 10 depends on the detail of the processing or the type of the process gas. For example, when formic acid is used as the process gas, the pressure is 40 to 1300 Pa, preferably 40 to 400 Pa. When the on-off valve 38 is opened, evaporated gas having reached its saturated vapor pressure in the evaporator 32 is subjected to flow rate control by the mass flow controller 40, and supplied to the process chamber 10 at a more reduced pressure. As a result, the pressure in the evaporator 32 decreases and the evaporation from the liquid surface is promoted.

When a steady state is reached, the pressure difference between upstream and downstream of the mass flow controller 40 becomes a constant value which is determined mainly by conditions such as the evaporation amount from the evaporator 32, the pressure in the process chamber 10 and the opening of the mass flow controller 40. In this apparatus, since the evaporator 32 has a cross-sectional area that can provide a liquid surface S which is large enough to allow the amount of reducing organic compound material L required in the process chamber 10 to evaporated at ambient temperature, an upper space in the evaporator 32 is generally almost saturated with the process gas under normal use conditions. Therefore, required process gas can be continuously evaporated in a statically stable state in the evaporator 32, and the accuracy of the control of the amount of the gas to be supplied to the process chamber 10 can be maintained at a high level.

Also, in this embodiment, since a carrier gas or the like is not mixed and only the reducing organic compound liquid is evaporated in the evaporator 32, interference of other gases does not occur and the gas without density unevenness can be stably supplied. In addition, since it is only necessary to maintain the evaporator 32 generally at room temperature, the apparatus configuration is fairly simple and the apparatus cost can be reduced.

It has been found that this apparatus is preferably used with the pressure in the evaporator 32 within the range of 80 to 100% of the saturated vapor pressure of the reducing organic compound, which depends on the temperature thereof. Typically, the apparatus is preferably used with the pressure in the evaporator 32 within the range of 80 to 100% of the saturated vapor pressure of the reducing organic compound generally at room temperature. This value is determined by the relation between the gas supply rate to the process chamber 10 and the gas evaporation rate in the evaporator 32, and decreases as the supply rate relatively increases. When the value was 80% or higher, uniform and stable surface processing could be carried out. On the other hand, it has been found that when the pressure in the evaporator 32 is lower than 80% of the saturated vapor pressure, it is difficult to maintain equilibrium between evaporation and supply during processing, resulting in unstable surface processing. Thus, an alarm may be set to sound when the pressure in the evaporator 32 becomes lower than 80% of the saturated vapor pressure based on the detection value from the gas source vacuum gauge 36 and the temperature measurement value.

It has been found that in this apparatus, when the ratio between the evaporation area (the area of the liquid surface of the reducing organic compound) in the evaporator 32 and the area of the substrate to be processed is 0.031 or greater, a constant amount of gas required for the processing can be stably supplied. This is described below.

For example, when the reduction reaction of copper oxide (Cu₂O) with formic acid gas as a carboxylic acid can be represented as follows:
Cu₂O+HCOOH→2Cu+H₂O+CO₂ (a)
the same number of formic acid molecules as the number of Cu₂O molecules are theoretically consumed in the reduction reaction. Thus, when 100% of the supplied gas is consumed as theoretically expected, the amount of formic acid gas necessary to reduce an oxide film with a unit film thickness of 1 nm on a wafer with a diameter size of 200 mm, for example, is calculated to be approximately 0.3 ml (the density of Cu₂O is assumed as 0.64 (according to Encyclopedia of Chemistry)).

In practice, however, a greater amount of the gas must be supplied because of the efficiency of the gas supply to the substrate surface and the reaction efficiency in the process chamber and so on. According to our experiment, the total reaction efficiency was approximately 50% at a substrate temperature of 300° C., and approximately 0.3% at a substrate temperature of 150° C. It has been found that the required amount of gas to be supplied must be increased exponentially as the processing temperature is lower. In addition, it has been found that when the required amount of gas is supplied by evaporating formic acid liquid, the ratio between the evaporation area in the evaporator 32 and the area of the wafer to be processed must be 0.031 or greater in a clean room environment at room temperature (23 to 25° C.).

For example, when reduction processing of a wafer with a diameter of 200 mm is carried out, an evaporation area of 9.8 cm² or greater is required to ensure the evaporation supply amount of formic acid gas required for the processing. Then, a constant amount of the gas required for the processing can be stably supplied. Also, the evaporation rate per unit area in the evaporating liquid surface at this time is estimated to be 20.4 cm³/min/cm² or less.

The process chamber 10 is preferably connected to a vacuum transportation system including a transportation chamber and a load lock chamber to avoid opening to the atmosphere when the substrate W is put in or taken out and to prevent re-oxidation after the surface processing.

As the throttle element, an orifice, capillary tube, throttle valve, or the like may be used. When the gas flow rate has been corrected in advance relative to the temperature in the evaporator 32 and the pressure in the process chamber 10, very inexpensive and simple flow rate control can be achieved.

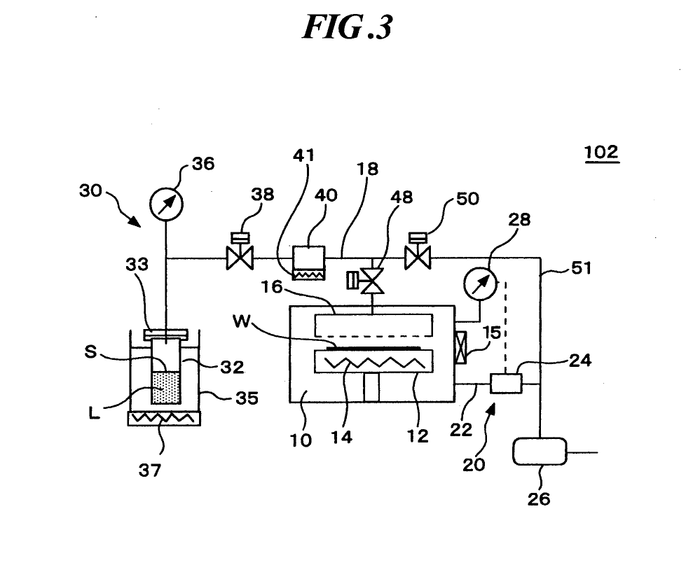

FIG. 3 illustrates a second embodiment of the present invention, which is an embodiment which can further increase the supply amount or which can be used even when the evaporation rate would be insufficient at room temperature because of the properties of the raw material. That is, the evaporator 32 of this embodiment is provided with a constant-temperature vessel 35 having a heater 37 (heating source), and the temperature in the evaporator 32 can be raised so that the apparatus can be used with the saturated vapor pressure raised. Also, when the processing pressure in the process chamber 10 is raised, the temperature in the evaporator 32 can be adjusted to room temperature or higher to maintain the saturated vapor pressure of the reducing organic compound equal to or higher than the processing pressure.

The apparatus of this embodiment is also provided with a function of switching between a vent operation for preparation of processing and a processing operation. That is, immediately before the start of processing in the process chamber 10, the reducing organic compound gas is supplied to the process gas pipe 18 and the throttle element 40 in advance with a process line valve 48 on the side of the process chamber 10 closed and a vent line valve 50 opened to discharge air into a vent line 51. At the start of processing, the process line valve 48 is switched open and the vent line valve 50 is switched closed to direct the reducing organic compound gas into the process chamber 10 through the shower head 16. In this case, the switching response at the start of the gas supply can be improved, and the uniformity of the processing of the surface of the substrate W can be improved. Also in this embodiment, a nozzle 16A as shown in FIG. 2 may be used in place of the shower head 16.

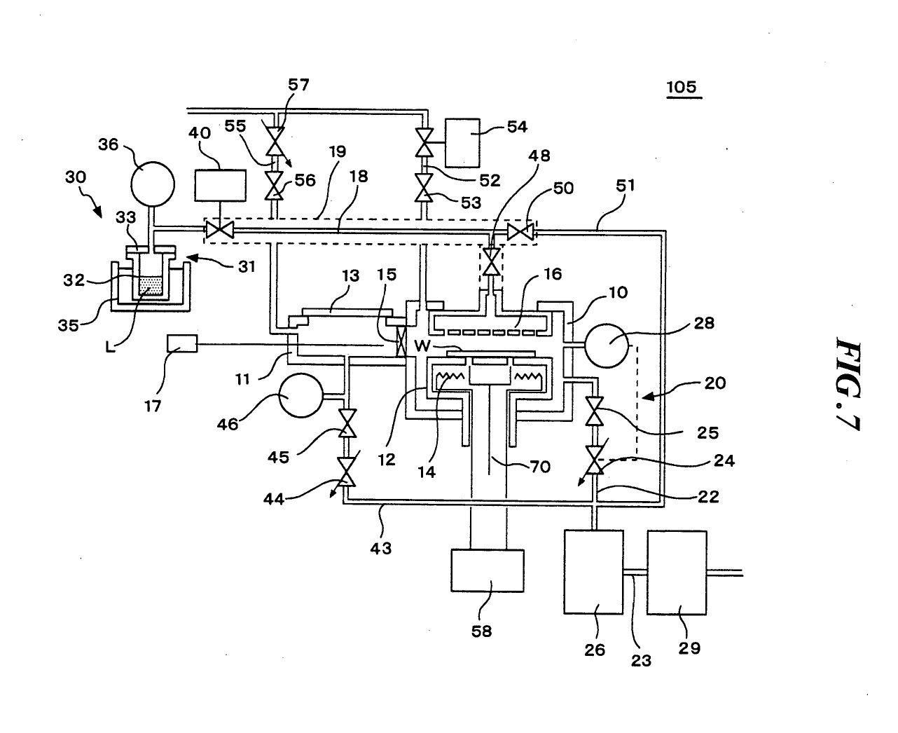

In this embodiment, a heater 41 for heating the secondary side section of the mass flow controller 40 including the mass flow controller 40 itself as a throttle element at a temperature equal to or higher than the temperature in the evaporator 32 as a primary side temperature is provided. This is to prevent the gas from being cooled or, in some cases, condensed by adiabatic expansion during passing through the mass flow controller 40. The process gas pipe 18 between the throttle element 40 and the process chamber 10 is also preferably provided with a heater 19 (see FIG. 7) for heating the process gas pipe 18 at a temperature equal to or higher than the temperature in the evaporator 32.

In the present invention, all of the vent line 51, the heater 37 for heating the evaporator 32 and the heater 41 for heating the mass flow controller 40 are not necessarily required together, and these may be combined as appropriate.

According to the apparatus and the method of the present invention, even when the pressure in the process chamber 10 varies slightly, the pressure on the primary side of the throttle element can be maintained at a prescribed value or higher. Therefore, gasification of a reducing compound and constant rate supply of the reducing compound can be carried out stably.

Also, since the mechanism for gasifying the reducing organic compound neither has a bubbler for supplying a constant amount of inert gas to the evaporator to promote evaporation using the gas as a carrier nor require a mechanism for uniform mixing with a carrier gas, the mechanism is simple and inexpensive and can achieve high reliability as a gas supply unit. In addition, since only the reducing organic compound gas is supplied for the processing, gas with high and uniform density can be obtained as the process gas, and uniform and quick substrate surface processing can be carried out.

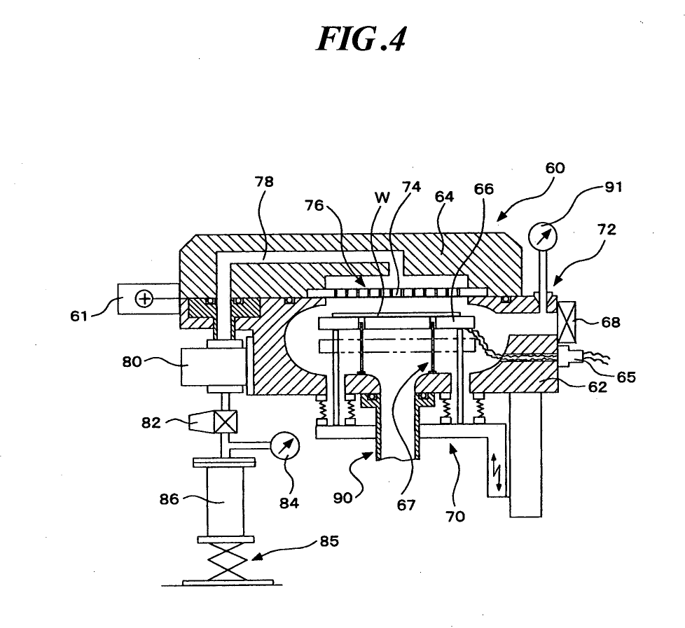

FIG. 4 illustrates a third embodiment of the present invention, showing a more specific apparatus constitution. A process chamber 60 is constituted of a chamber body 62 and an openable lid 64 rotatably attached to the chamber body 62 by a hinge 61 for covering the chamber body 62 gas-tightly. The chamber body 62 is provided with a substrate stage 66 in which a substrate heater for heating a substrate W with electric power introduced through a current introduction terminal 65 is incorporated, a gate valve 68 through which the substrate W can be transported into and out of the chamber 60, an elevating mechanism 70 for moving up and down the substrate stage 66, push-up pins 67 for pushing up the substrate W along with downward movement of the substrate stage 66 when the substrate W is transported into and out of the chamber 60, and an evacuation control system 72. The evacuation control system 72 has an evacuation pipe 90 located below the substrate stage 66, a pressure adjusting valve (see FIG. 3) provided in the evacuation pipe 90, and a vacuum gauge 91 for measuring the pressure in the process chamber 60.

A shower head 76 having a porous plate 74 and a gas passage 78 are formed in the openable lid 64. A throttle element 80 is secured to an outer wall of the chamber body 62, and has a secondary side passage which is gas-tightly communicated with the gas passage 78 for the shower head 76 when the openable lid 64 is closed. A shut off valve 82, a pressure gauge (vacuum gauge) 84, and a gastight evaporator 86 containing a reducing organic compound liquid are connected to the primary side of the throttle element 80. The evaporator 86 is supported by a support adjustment table 85.

In this embodiment, since the throttle element 80 is secured to a side wall of the chamber body 62, the throttle element 80 is heated by heat transferred from the substrate heater in the substrate stage 66 to a temperature higher than room temperature. The temperature is adjusted in advance by the attachment area of the throttle element 80 or a heat insulating material interposed as needed. Also, the gas passage between the throttle element 80 and the shower head is also heated by heat transferred from the substrate heater and so on. The throttle element 80 may be heated by radiant heat.

In the above configuration, since the throttle element 80 is especially heated directly by the process chamber 60, temperature drop of the evaporated gas by adiabatic expansion in the throttle element 80 can be prevented and condensation of the gas can be prevented. Therefore, a constant supply rate of gas can be stably carried out. In the above embodiment, since the gas passage 78 on the secondary side of the throttle element 80 is also heated, condensation of the gas is even less likely to occur. Also, the gas passage 78 is configured to be gastight to the openable lid 64 and the chamber body 62, the effect is achieved that maintenance of the chamber can be carried out easily.

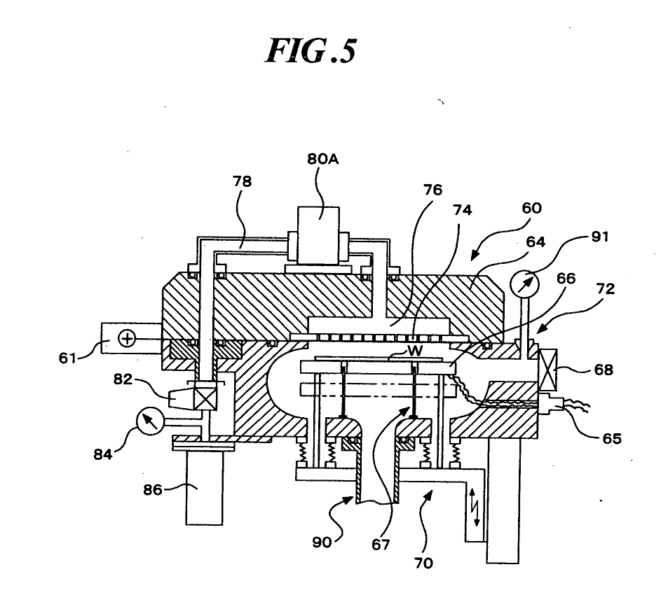

FIG. 5 illustrates a fourth embodiment of the present invention, in which a throttle element 80A is secured to the openable lid 64 so that the throttle element 80A can receive heat from the openable lid 64. It is needless to say that effects similar to those of the third embodiment can be obtained.

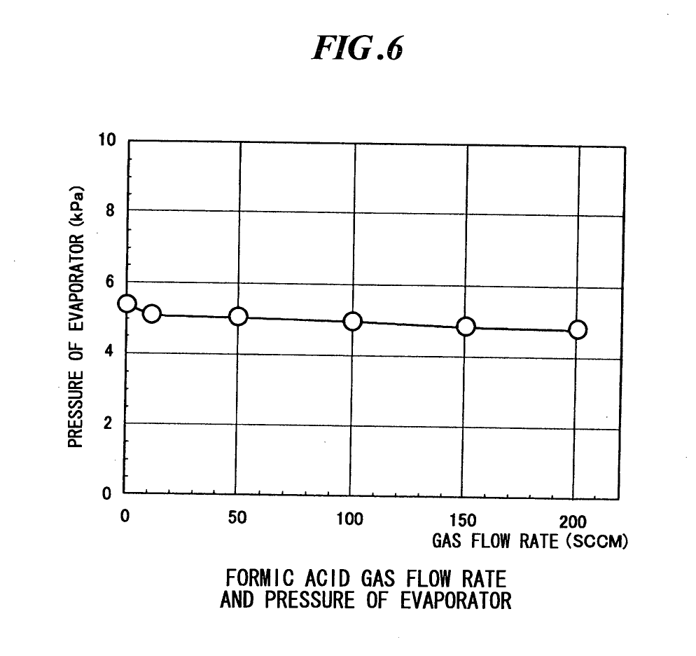

One example of a substrate processing apparatus according to the present invention is described below with a more specific example. The apparatus of the embodiment shown in FIG. 1 was used and formic acid was used as the carboxylic acid for the reducing organic compound. An evaporator 32 with an evaporation area (cross-sectional area at the liquid level) of 9.8 cm² containing formic acid liquid with a purity of approximately 100% was maintained at room temperature (23 to 25° C.), and the process gas was supplied to the process chamber 10 with a processing pressure of 40 to 1300 Pa in the process chamber 10. A minute differential pressure mass flow controller SFC670 series (product name) manufactured by Hitachi Metals, Ltd. was used as the mass flow controller 40 to control the flow rate. As shown in FIG. 6, stable gas supply could be achieved at least in the range of 25 to 200 SCCM (cm³/min at 0° C. and 1 atmospheric pressure). At this time, the saturated vapor pressure was approximately 5.3 kPa.

Referring next to FIG. 7, the constitution of a surface processing apparatus according to a fifth embodiment of the present invention is described. The surface processing apparatus has a gastight process chamber 10 in which surface processing of a substrate W such as a semiconductor wafer is carried out, a load lock chamber 11 through which the substrate W is put in and taken out of the process chamber 10, a process gas supply system 30 for supplying a process gas to the process chamber 10, and an evacuation control part 20 for maintaining the inside of the process chamber 10 and the load lock chamber 11 at a prescribed vacuum level.

A substrate stage 12 for supporting thereon the substrate W with a heater 14 incorporated therein for heating the substrate W at a prescribed temperature is provided in the process chamber 10. A shower head 16 as a process gas supply port for uniformly diffusing and supplying the process gas onto an entire substrate surface through a porous plate is provided above the substrate stage 12. The load lock chamber 11, which is located adjacent to the process chamber 10, can receive a substrate W from the outside and pass it to the outside through an openable lid 13, and can pass the substrate W into the process chamber 10 and receive it from the process chamber 10 through a gate valve 15 with a transportation arm 17. An elevator 70 as an elevating mechanism is provided in the substrate stage 12. The substrate W transported from the load lock chamber 11 by the transportation arm 17 is lifted up and supported by push pins at an end of the elevator 70, and is put down on the substrate stage 12 after the transportation arm 17 has been retracted into the load lock chamber 11. The port opening through which the substrate W is transported into the load lock chamber 11 from the outside and out of the load lock chamber 11 to the outside is not necessarily formed in the top of the load lock chamber. The port opening may be formed in any of the top, bottom and sides of the load lock chamber as long as the transportation of the substrate W is not interfered with. Also, the structure of the port opening to maintain the pressure in load lock chamber 11 is not limited to the openable lid 13. In addition, the method for driving the push pin is not limited to a manual operation. The process gas supply port is not limited to a shower head, and a nozzle 16A with one or a plurality of holes formed thereto as shown in FIG. 2, for example, may be used instead. Even when the nozzle is used, the process gas can be supplied uniformly onto an entire surface of the substrate W as in the case where a shower head is used.

The evacuation control part 20 has an evacuation pipe 22, a load lock chamber evacuation pipe 43, a vacuum evacuation pump 26 provided in an evacuation pipe 23 to which the evacuation pipe 22 and the load lock chamber evacuation pipe 43 are joined, and a detoxification device 29 for removing unreacted components and byproducts in exhaust gas. The evacuation pipe 22 and the load lock chamber evacuation pipe 43 are provided with on-off valves 25 and 45, respectively, and a pressure adjusting valve 24 and a flow rate adjusting valve 44, respectively, so that the process chamber 10 and the load lock chamber 11 can be evacuated with the flow rates controlled separately. The process chamber 10 and the load lock chamber (exit) are provided with a chamber vacuum gauge 28 and a vacuum gauge 46, respectively. Therefore, the pressure adjusting valve 24 is controlled based on the output from the chamber vacuum gauge 28 to maintain the inside of the process chamber 10 at a prescribed pressure. In this embodiment, the vacuum evacuation pump 26 is a dry pump, and the detoxification device 29 is a dry exhaust-gas-processing device. The vacuum evacuation pump 26 may have two or more dry pumps connected in series or a dry pump and a turbo-molecular pump connected in series depending on the evacuation performance. Also, the detoxification device 29 may not necessarily be of a dry type but may be of a wet type, a combustion type or a combination thereof.

The process gas supply system 30, which supplies formic acid gas as a reducing organic compound, has a process gas evaporator 31 and a process gas pipe 18 for communicating the process gas evaporator 31 with a process gas supply port 16 of the process chamber 10. The process gas evaporator 31 is constituted of a gastight evaporator 32 containing formic acid liquid L and a constant-temperature vessel 35 surrounding the evaporator 32. An openable lid 33 is gas-tightly attached to an upper part of the evaporator 32, and an end of the process gas pipe 18 opens in the openable lid 33. The process gas pipe 18 is provided with a gas source vacuum gauge 36 and a mass flow controller 40, and a heater 19 for keeping the temperature of a downstream part including the mass flow controller 40 is provided. A vent line 51 branched from the process gas pipe 18 and communicated with the vacuum evacuation pump 26 bypassing the process chamber 10 is provided. A process line valve 48 is provided in the portion of the process gas pipe 18 downstream of the branch point and a vent line valve 50 is provided in the vent line 51, respectively. The constant-temperature vessel 35 is not limited to a liquid vessel as illustrated as long as it can maintain the evaporator 32 at a constant temperature.

The process gas supply system 30 can maintain the formic acid liquid L in the evaporator 32 at a prescribed temperature by adjusting the temperature in the constant-temperature vessel 35, and can supply formic acid gas at a prescribed flow rate by adjusting the opening of the mass flow controller 40 while monitoring the formic acid saturated vapor pressure in the space above the liquid in the evaporator 32 with the gas source vacuum gauge 36.

Nitrogen gas introduction pipes 52 and 55 are connected to the process chamber 10 and the load lock chamber 11, respectively, and nitrogen gas is introduced at a prescribed flow rate into the process chamber 10 through an on-off valve 53 by a mass flow controller 54 and into the load lock chamber 11 through an on-off valve 56 by a variable valve 57. A mass flow controller may be used in place of the variable valve 57.

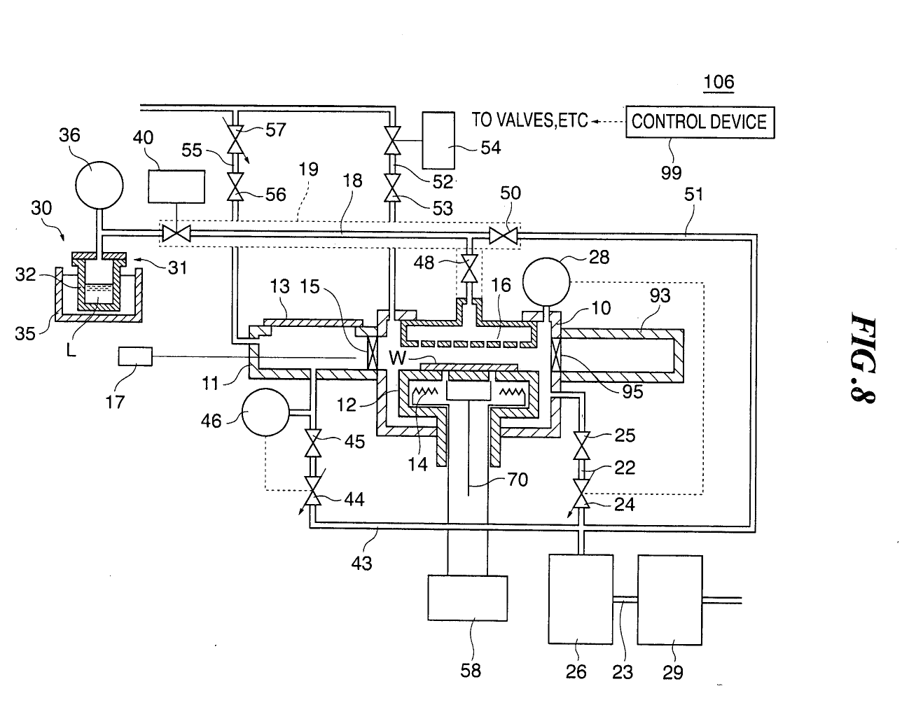

Referring next to FIG. 8, a substrate processing apparatus according to a sixth embodiment of the present invention is described. A substrate processing apparatus 106 according to the sixth embodiment has another process chamber 93 besides the process chamber 10, and a control device 99 in addition to the constitution of the substrate processing apparatus 105 shown in FIG. 7. The another process chamber 93 is connected to the process chamber 10 via a gate valve 95. The control device 99 is connected to the mass flow controllers 40 and 54, the pressure adjusting valve 24, the flow rate adjusting valve 44, the variable valve 57 and so on by signal cables (not shown), and configured to be able to adjust the opening of the valves according to signals and control the outputs of the heater 14 in the substrate stage 12 and the heater 19 provided around the process gas pipe 18 and so on.

The process for removing an oxide film as an oxide generated on a surface of a copper film as a metal formed on a surface of a substrate W, for example, in the surface processing apparatus constituted as described above is described.

First, after the process chamber 10 is preliminarily evacuated with the vacuum evacuation pump 26 to produce a vacuum therein, nitrogen gas is introduced from the nitrogen gas introduction pipe 52 through the mass flow controller 54 into the process chamber 10 to maintain the inside of the process chamber 10 at an oxide film removing process pressure (for example, 40 Pa). A heater power source 58 has been switched on in advance to maintain the substrate stage 12 at a prescribed temperature.

Next, after the load lock chamber 11 is brought to atmospheric pressure, and the lid 13 of the load lock chamber is opened and a substrate W is placed on the transportation arm 17. Then, the lid 13 is closed and the load lock chamber 11 is evacuated to produce a vacuum therein. Then, after the gate valve 15 is opened and the substrate W is transported into the process chamber 10, the substrate W is placed in position on the substrate stage 12 using the elevator 70 and heated to a prescribed temperature (for example, 200° C.).

At the same time, in the process gas evaporator 31, the temperature of water in the constant-temperature vessel 35 is adjusted to maintain the temperature of the formic acid liquid L at a prescribed value and adjust the formic acid vapor pressure in the space above the liquid. The vapor pressure is measured with the gas source vacuum gauge 36. The formic acid gas is caused to flow through the mass flow controller 40 and the vent line valve 50 at a prescribed flow rate (for example, 50 SCCM).

Next, when it is determined that the formic acid vapor pressure has reached a prescribed pressure at a predetermined temperature, the on-off valve 53 is closed to stop the introduction of nitrogen gas into the process chamber 10, and the vent line valve 50 is closed and the process line valve 48 is opened to introduce the formic acid gas into the process chamber 10 through the process gas supply port 16. The formic acid pressure during the processing is maintained at a prescribed pressure (for example, 40 Pa) through flow rate control by the mass flow controller 40 and by feeding back the result of measurement by the chamber vacuum gauge 28 to the variable valve 24 to control the valve opening thereof.

By exposing a surface of the substrate W heated at a prescribed temperature to the formic acid gas at a prescribed pressure for a prescribed period of time in this state, the natural oxide film on a surface of the copper film on the surface of the substrate W is removed. After a prescribed period of time elapses, the process line valve 48 is closed to stop the introduction of the formic acid gas, and the substrate W is separated from the substrate stage 12 using the elevator 70. The substrate W is transported into the load lock chamber 11 by the transportation arm 17, and nitrogen gas is introduced into the load lock chamber 11 by opening the valve 56 and adjusting the opening of the variable valve 57 until the pressure in the load lock chamber 11 reaches atmospheric pressure. After that, the valve 56 is closed and the apparatus waits until the substrate W is cooled. When the substrate W is cooled, the openable lid 13 of the load lock chamber is opened and the substrate W is taken out, whereby the processing is completed. Then, nitrogen gas is supplied to the process chamber 10 by opening the valve 53 to discharge the formic acid therein and the process chamber 10 is evacuated to produce a vacuum therein in order to repeat the next processing step.

It is considered that, in the above surface processing, the lower the temperature of the substrate W heated on the substrate stage 12, the less the substrate W is adversely affected. However, it is considered that when the temperature is too low, the reaction to remove the oxide film with formic acid does not progress or is slowed to the extent that it is not practically appropriate. Thus, to elucidate practical processing conditions at a low temperature, a processing experiment was carried out on a substrate W. The temperature of the formic acid liquid L was fixed at 27° C. in the processing experiment. Incidentally, the saturated vapor pressure of formic acid is 5320 Pa when the liquid temperature is 24° C. and 101300 Pa (atmospheric pressure) when the liquid temperature is 100.6° C.

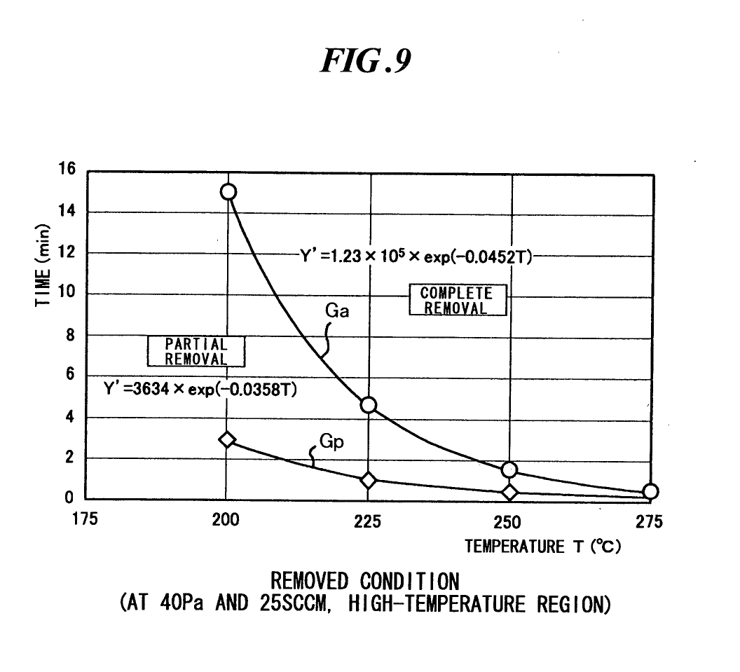

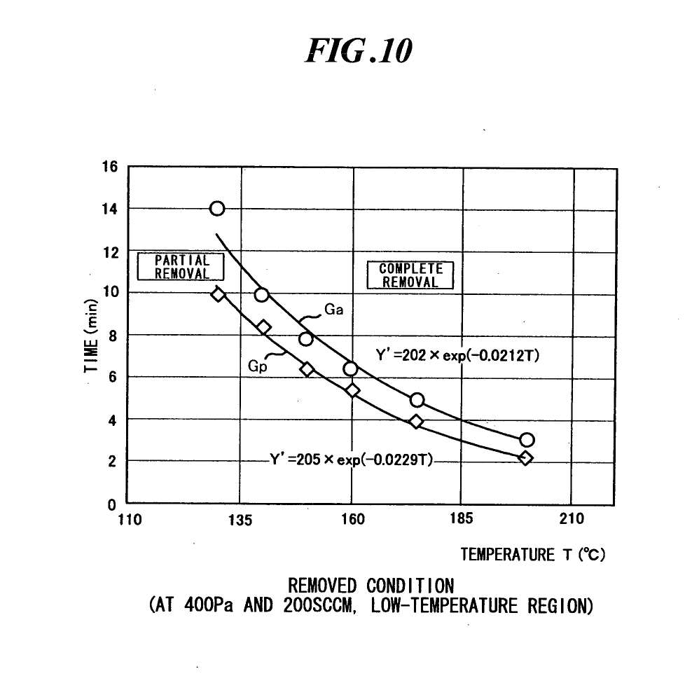

A processing for removing an oxide film on a copper film formed on a substrate W with a diameter of 200 mm was carried out. The thickness of the oxide film formed on the substrate W was 20 nm. The processing conditions were a formic acid gas pressure of 40 Pa and a formic acid gas flow rate of 25 SCCM in a seventh embodiment, and a formic acid gas pressure of 400 Pa and a formic acid gas flow rate of 200 SCCM in an eighth embodiment. The temperature of the substrate W was changed between 130 and 300° C., and the processing time was appropriately set. Then, the state of the oxide film was observed. The results are respectively shown in FIG. 9 (seventh embodiment) and FIG. 10 (eighth embodiment).

In these drawings, the “complete removal” curve Ga is a border line between the region in which the oxide film on the entire surface of the substrate W was completely removed and the region in which only a part of the oxide film was removed, and the “partial removal” curve Gp is a border line between the region in which the oxide film was removed and the region in which the oxide film was not removed at all. That is, it can be understood that when the processing is carried out at a certain substrate W temperature and a certain process gas pressure, a part of the oxide film on the metal starts to be removed when the period of time corresponding to the “partial removal” elapses, and then the removal of the oxide film on the metal is completed when the period of time corresponding to the “complete removal” elapses.

Here, to calculate practical processing time, a curve connecting intermediate values between the complete removal curve Ga and the partial removal curve Gp is defined as “practical removal” curve. This is because it is determined that when the period of time corresponding to the “practical removal” curve has elapsed, a significant proportion of the oxide film has already been removed, and the remaining oxide film has been sufficiently decreased in thickness and it is considered that there is no possibility of interfering with electrical communication between electric lines. As described above, when the processing time is set based on results obtained experimentally, processing with required quality can be carried out without conducting unnecessary processing.

It is needless to say that since the setting of the “practical removal” curve is eventually determined based on the evaluation in the following stages, it can be set in a region between the complete removal curve and the partial removal curve, or in a region outside the range as appropriate. For example, when the complete removal curve is employed as the “practical removal” curve, a minimum period of time required for removal from the entire surface can be set and unnecessary processing can be avoided.

The “oxide film removal limit” in the case shown in FIG. 9 where the oxide film has a thickness of 20 nm and the formic acid gas pressure is set to 40 Pa can be represented by the following equation. The oxide film removal limit herein means a curve representing the average of the above complete removal curve and the partial removal curve. Here, the period of time required to remove the oxide film is represented by Y′ (minutes), and the temperature of the substrate W is represented by T (° C.).
Y′=(1.23×10⁵×exp(−0.0452T)+3634×exp(−0.0358T))/2 (1)
From the equation (1), the processing time Y (minutes/nm) required to remove the oxide film with a unit thickness is represented by the following equation.
Y=Y′/20=(1.23×10⁵×exp(−0.0452T)+3634×exp(−0.0358T))/40 (2)

For reference, values of Y′ calculated from the equation (1) are shown in Table 1.

TABLE 1

| Temperature (° C.) | Removal limit time (min) |
|---|---|
| 200 | 8.7 |
| 225 | 2.9 |
| 250 | 1.0 |
| 275 | 0.3 |

Also, the “oxide film removal limit” in the case shown in FIG. 10 where the formic acid gas pressure is 400 Pa is represented by the following equation.
Y′=(202×exp(−0.0212T)+205×exp(−0.0229T))/2 (3)

From the equation (3), the processing time Y (minutes/nm) required to remove the oxide film with a unit thickness is represented by the following equation.
Y=Y′/20=(202×exp(−0.0212T)+205×exp(−0.0229T))/40 (4)

For reference, values of Y′ calculated from the equation (3) are shown in Table 2.

TABLE 2

| Temperature (° C.) | Removal limit time (min) |
|---|---|
| 130 | 11.6 |
| 140 | 9.3 |
| 150 | 7.5 |
| 160 | 6.0 |
| 175 | 4.3 |
| 200 | 2.5 |

The oxide film removal limit may be the complete removal curve described before. That is, when the oxide film has a thickness of 20 nm, the equation representing the complete removal curve in FIG. 9
Y′=1.23×10⁵×exp(−0.0452T)
may be used when the process gas pressure is in the range of 40 Pa or higher, and the equation representing the complete removal curve in FIG. 10
Y′=202×exp(−0.0212T)
may be used when the process gas pressure is in the range of 400 Pa or higher.

Also, when the oxide film removal limit is as described above, the processing time Y (minutes/nm) required to remove the oxide film with a unit thickness is represented as follows.

When the process gas pressure is in the range of 40 Pa or higher,
Y=(1.23×10⁵×exp(−0.0452T))/20
and when the process gas pressure is in the range of 400 Pa or higher,
Y=(202×exp(−0.0212T))/20.

As a result, it has been found that when the formic acid gas pressure is high, the oxide film can be removed at a lower temperature. It has also been found that when the thickness of the oxide film is different from the above, the processing time is generally proportional to the film thickness with respect to the processing time described below. It is needless to say that the upper limit of the process gas pressure must be equal to or lower than the saturated vapor pressure at the liquid temperature of a reducing organic acid in a carburetor.

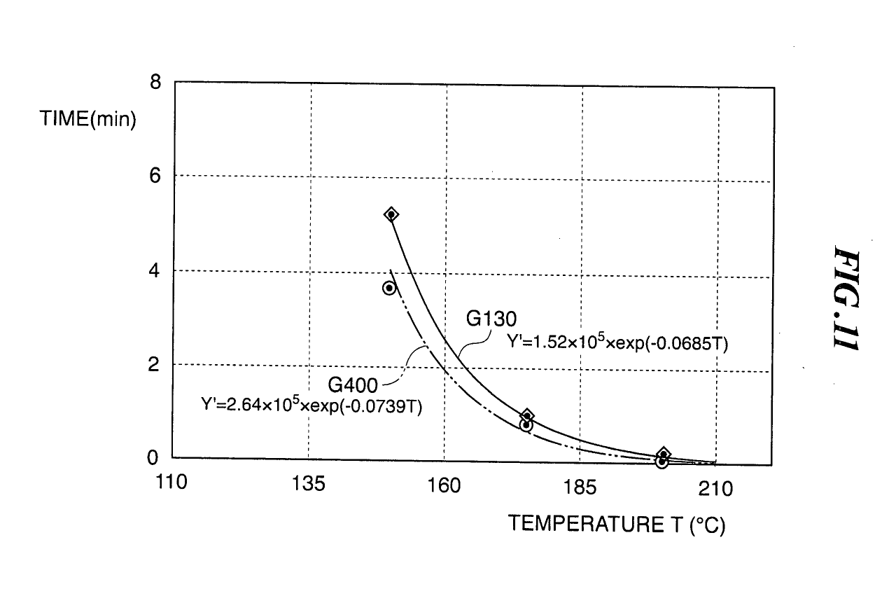

In the above, the processing conditions for oxide films, especially for a forced oxide film with a thickness of around 20 nm, are described. In an actual processing step, a natural oxide film with a thickness around 2 nm is often processed. Therefore, the result of investigation conducted similarly to determine oxide film removing conditions for a natural oxide film is next described as a ninth embodiment based on FIG. 11.

FIG. 11 shows the relation between the processing temperature and the processing time when a natural oxide film on copper as a metal formed on a surface of a substrate W was processed. The horizontal axis represents the processing temperature, and the vertical axis represents the processing time at which the removal of the natural oxide film was completed. A complete removal curve G130 at a processing pressure of 130 Pa and a complete removal curve G400 at a processing pressure of 400 Pa are shown in FIG. 11. The equations representing the complete removal curves G130 and G400 are shown below. The relation between the substrate temperature T (° C.) during the processing and the processing time Y′ (minutes) required to remove the natural oxide film at a process gas pressure of 130 Pa is represented by the following equation.
Y′=1.52×10⁵×exp(−0.0685T) (5)

When the thickness of the natural oxide film at this time is assumed to be 2 nm, the period of time Y (minutes/nm) required to remove the natural oxide film with a unit thickness is represented by the following equation.
Y=Y′/2=0.76×10⁵×exp(−0.0685T) (6)

The relation between the substrate temperature T (° C.) during the processing and the processing time Y′ (minutes) required to remove the natural oxide film with a unit thickness at a process gas pressure of 400 Pa is represented by the following equation.
Y′=2.64×10⁵×exp(−0.0739T) (7)

When the thickness of the natural oxide film at this time is assumed to be 2 nm as in the case with the 130 Pa case, the period of time Y (minutes/nm) required to remove the natural oxide film with a unit thickness is represented by the following equation.
Y=Y′/2=1.32×10⁵×exp(−0.0739T) (8)

The natural oxide film can be removed at a temperature and in a period of time which are higher and longer than the boundaries defined by the above equations respectively.

As described above, it has been found that the processing can be carried out at a relatively low temperature around 200° C. when the process gas pressure is set to a prescribed value, and practical temperature/pressure conditions could be selected in relation to the processing time.

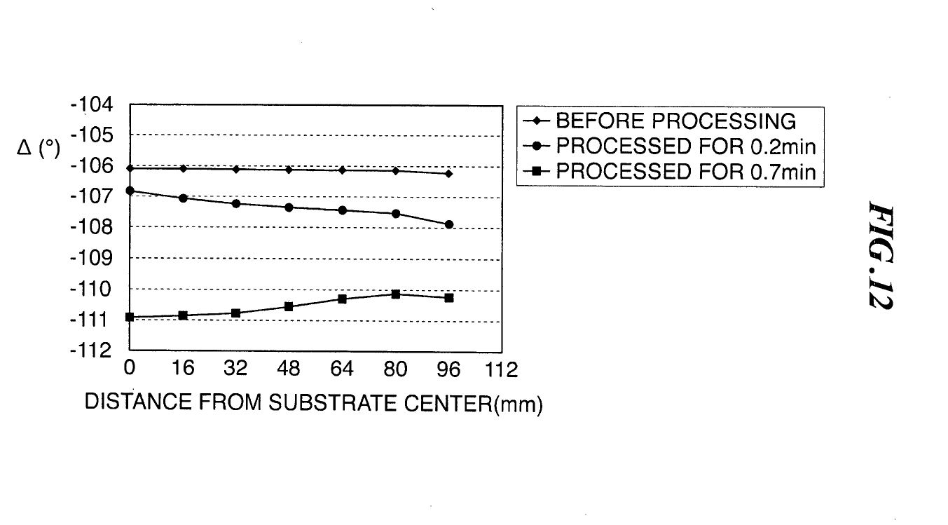

Next, the result of removal of an oxide film carried out using the nozzle 16A with one or a plurality of holes as shown in FIG. 2 as a specific mechanism for the process gas supply port in place of the shower head 16 is described. FIG. 7 shall be referred to as needed for explanation of the reference numerals in this description. First, FIG. 12 shows the result in the case where a natural oxide film was removed using the shower head 16. The shower head 16 has about 400 holes with a diameter of 0.5 mm arranged at intervals of 10 mm. In the drawing, the horizontal axis represents the position on the substrate W from the left end thereof placed at the center of the substrate W, and the vertical axis represents the phase difference Δ between the s-polarized light and p-polarized light as one of values measured with an ellipsometer. The phase difference Δ can be an index of the thickness of the natural oxide film. The unit of the phase difference Δ is ° (degree). A phase difference Δ of approximately −110 or less indicates a state in which no oxide film exists, and a phase difference Δ of around −106 indicates a natural oxide film with a thickness of 2 to 3 nm. In FIG. 12, the “before processing” plot represents the phase differences Δ before the processing with this apparatus and has values of approximately −106, the “processed for 0.7 min” plot represents a state where the removal of oxide film has been completed, and the “processed for 0.2 min” plot represents a state between the above two states. It can be understood that the thickness of the oxide film is decreased generally uniformly within the surface of the substrate W in both the states.

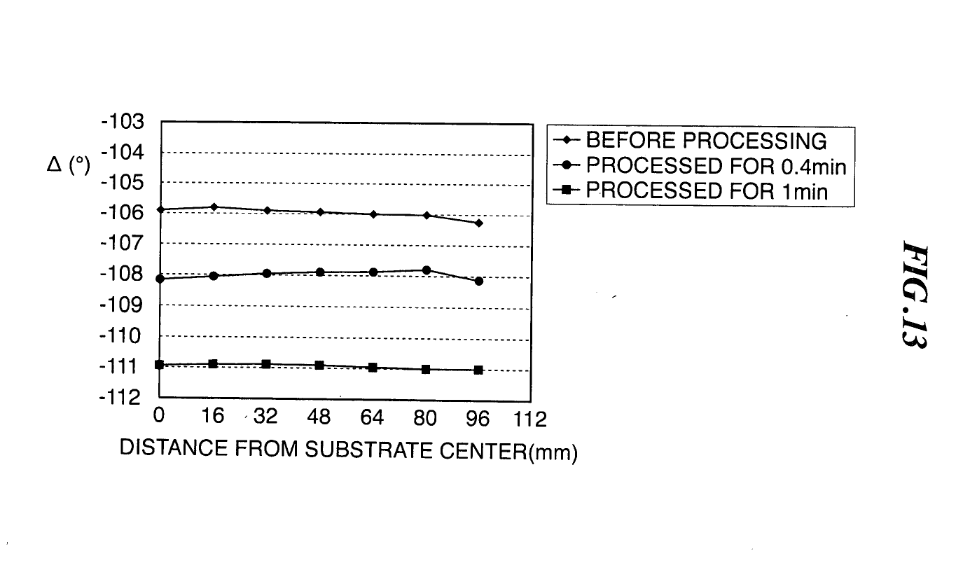

FIG. 13 shows the result of the processing carried out using a single-hole nozzle 16A having a hole with a diameter of 12 mm and disposed, in place of the shower head 16, above the center of the substrate W. The distance H from the lower end of the nozzle 16A to the substrate W is 50 mm. The conditions (such as the flow rate of formic acid and so on) were the same as those in the above case where the shower head 16 was used, except that the shower head 16 was replaced with the nozzle 16A. As shown in FIG. 13, the thickness of the oxide film was decreased generally uniformly as the state progressed from the “before processing” to “processed for 0.4 min” and to “processed for 1 min.”

As can be understood from above, it can be determined that the shower head 16 and the nozzle 16A have generally the same oxide film removal performance as a mechanism for the process gas supply port. The position of the nozzle 16A is preferably above the center of the substrate W as describe above but is not limited thereto. Also, the blowout direction is preferably perpendicular to the surface of the substrate W but is not limited thereto as long as the nozzle 16A is located in such a position where it can supply the process gas onto the entire surface of the substrate W.

When an equation for calculating a parameter as described above, such as equation (1) and equation (3), or equation (6) and equation (8), or a lookup table (reference table) has been inputted in to a controlling computer (which is typically provided in the control device 99) and desired processing conditions are inputted based on the input equation or table, the computer can be adapted to calculate and output other process parameters or the apparatus can be adapted to operate automatically based on the output from the computer.

Typically, as has been described above, an oxide film is removed by supplying formic acid gas as an evaporated reducing organic compound to the substrate W heated on the substrate stage 12. Therefore, the damage to the copper wiring or the semiconductor device can be reduced as compared to the case where plasma or the like is used. However, the present inventors have observed a phenomenon in which when copper oxide as an oxide film on a surface of copper wiring was removed by supplying an evaporated reducing organic compound to a substrate W, copper or a compound thereof was consequently scattered on and around the substrate W. That is, this indicates that the mechanism for removing an oxide film involves not only a reduction reaction as represented by the chemical formula (a) but also more complex reactions. As a result of high precision measurement as described later, the present inventors have found that etching occurs simultaneously with the reduction reaction as a mechanism for removing an oxide film. Although the amount of copper or a compound thereof scattered by the etching reaction is small, the amount cannot be disregarded in the copper wiring structure or the like on semiconductor devices in recent years showing a tendency toward miniaturization. In the mechanism for removing an oxide film, an etching reaction represented by a chemical formula (b) below and a reduction reaction represented by a chemical formula (c) below occur simultaneously in addition to a reduction reaction represented by the chemical formula (a) described before.
Cu₂O+2HCOOH→2Cu(HCOO)+H₂O (b)
2Cu(HCOO)→2Cu+2CO₂+H₂ (c)

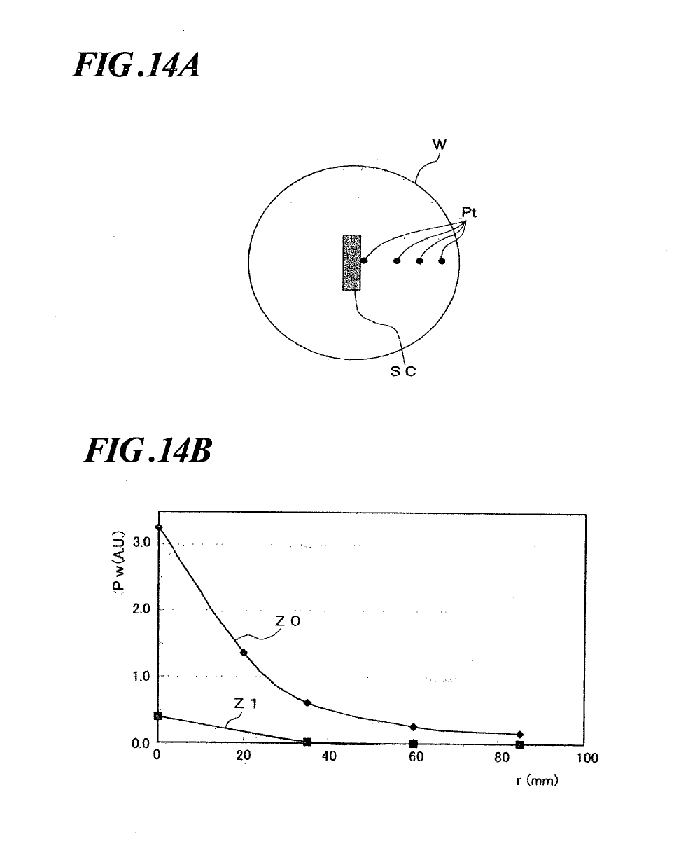

The high precision measurement as described before, which allowed the inventors to find the fact that an etching reaction, occurs in addition to a reduction reaction was conducted as described below. It is described with reference to FIG. 14. First, to check the amount of copper which is scattered by supplying formic acid to the substrate W, a copper piece SC on which copper oxide as an oxide film has been generated was attached to a substrate W, which is an Si wafer with a diameter of 200 mm, as shown in FIG. 14A, and the oxide film removing processing was performed on the substrate W placed on the substrate stage 12. At this time, the processing temperature was 200° C., the processing pressure was 400 Pa, and the time for processing using formic acid was 10 minutes. After the oxide film removing processing, the formic acid gas was stopped and heating of the substrate W was immediately stopped. Then, the copper piece SC was removed from the substrate W put down from the substrate stage 12, and the distribution Pt of the amount of scattered copper was measured using a time-of-flight secondary ion mass spectrometer (TOF-SIMS). The relation between the distance r from the position where there was the copper piece and the signal intensity PW of copper atoms is shown as Z0 in FIG. 14B. The amount of copper atoms was large in the area around where the copper piece SC was attached and decreased with an increase in distance. It was observed that copper atoms had scattered from the copper piece SC with copper oxide to the area around it. That is, it is estimated that during the removal of the oxide film, the oxide film was reacted with formic acid gas molecules, and some of the oxide film was reduced and some of the oxide film was scattered in the form of copper formate Cu (HCOO) with a vapor pressure and adhered to the substrate W again. The vapor pressure is higher as the temperature is higher, and some of the adherent copper formate is discharged as vapor.

Then, a substrate processing method for removing a copper compound which is formed by a reaction between an oxide film generated on the metal portion on a surface of the substrate W and the formic acid gas and scatters is next described.

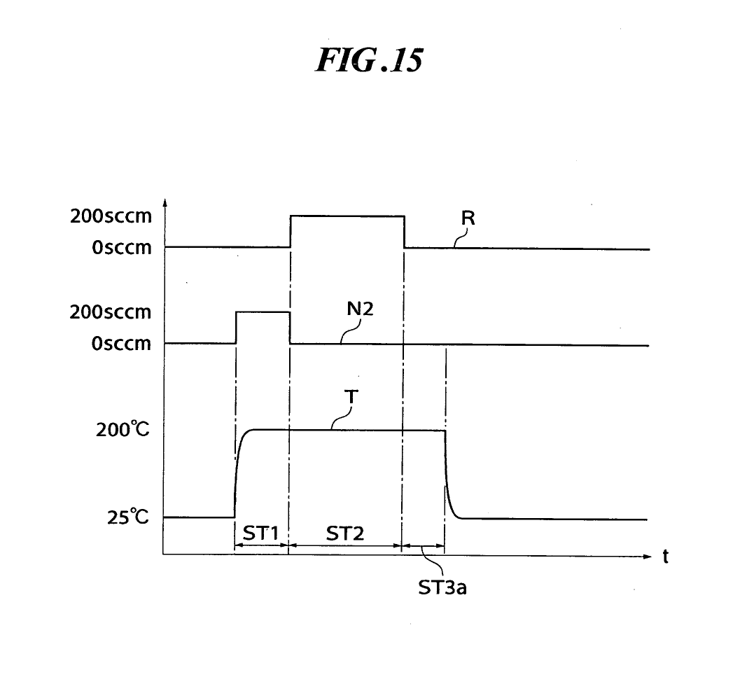

FIG. 15 is a time chart for explaining a substrate processing method according to a tenth embodiment of the present invention. First, a substrate W to be processed is placed on the substrate stage 12 in the process chamber 10, and the substrate w is preheated until the substrate W reaches the temperature at which the oxide film generated on the metal on the substrate W is removed (ST1). The temperature of the substrate W at which the oxide film is removed is a first prescribed temperature. The first prescribed temperature is 140 to 250° C., preferably 160 to 210° C., more preferably 175 to 200° C., much more preferably 180 to 195° C. In the drawing, T represents the changes in the substrate temperature. During the preheating, nitrogen gas is supplied to prevent the substrate W from being exposed to an oxidative atmosphere. In the drawing, N2 represents the changes in the supply rate of nitrogen gas. When the substrate W is heated to the first prescribed temperature, an evaporated reducing organic compound is supplied to the substrate W to start the removal of the oxide film generated on the metal portion on the surface of the substrate W (ST2). In the drawing, R represents the changes in the supply rate of formic acid gas. In the steps up to this point (ST1 and ST2), the substrate processing method described before is typically used.

When the processing time for removing the oxide film (ST2) is completed, the supply of the formic acid gas is stopped and the process chamber 10 is evacuated. Meanwhile, the substrate W is held on the substrate stage 12 for a first prescribed period of time with the heater kept on to maintain the temperature of the substrate W at the first prescribed temperature (ST3a). The first prescribed period of time is determined based on the thickness of the oxide film to be processed, and the processing time must be longer as the film thickness is larger. The first prescribed period of time is at least 3 seconds, preferably at least 10 or 20 seconds and not longer than 5 minutes. This is because it is difficult to determine whether or not the substrate W has been maintained at the first prescribed temperature after the oxide film removing processing when the first prescribed period of time is too short, and the first prescribed period of time that is too long is not practical from the viewpoint of the constitution and throughput of recent substrate processing apparatuses in which a sheet-fed wafer processing is generally performed. Next, an additional explanation is given about the temperature of the substrate W. When the process chamber 10 is evacuated until the inside thereof becomes close to a vacuum, the formic acid molecules do not exist between the substrate W and the substrate stage 12 any more where they did in a microscopic sense. Thus, the temperature of the substrate W drops as the evacuation of the process chamber 10 progresses, and the range of drop in the temperature of the substrate W caused thereby is herein included in the concept of maintaining at the first prescribed temperature. When the temperature of the substrate W is maintained at the first prescribed temperature for the first prescribed period of time after the removal of the oxide film as described above, the copper compound remaining and adsorbed on the surface of the substrate W can be separated and removed therefrom since the reaction represented by the above chemical formula (c) occurs and some of the copper compound is discharged in the form of copper formate vapor. After the copper compound scattered on a surface of the substrate W by the etching reaction has been removed by the above reaction, the substrate W is put down from the substrate stage 12, cooled and taken out of the process chamber 10, whereby the processing is completed.

FIG. 14B shows the result of experiment conducted to confirm whether or not the copper compound scattered by an etching reaction has been removed from the substrate W. This experiment was conducted under the same conditions under which the high precision measurement described before, by which the etching reaction was found, was carried out. That is, a substrate of a Si wafer to which a copper piece on which copper oxide as an oxide film had been generated was attached was used. The processing temperature was 200° C., the processing pressure was 400 Pa, and the time for processing using formic acid was 10 minutes. After the oxide film removing processing, the substrate was maintained at the first prescribed temperature for the first prescribed period of time. Then, the copper piece SC was removed from the Si wafer put down from the substrate stage 12, and the distribution of the amount of scattered copper was measured using a time-of-flight secondary ion mass spectrometer (TOF-SIMS). The relation between the distance from the position where there was the copper piece and the signal intensity of copper atoms is shown as Z1 in FIG. 14B. It was confirmed from the drawing that the amount of copper atoms which adhered again was reduced to one-eighth or less as compared to the case where the wafer was cooled immediately after the oxide film removing processing. This is considered to be because when the pressure is lwered while heating the substrate W after the oxide film removing processing, collisions of molecules decrease and separation of the copper compound is promoted as a whole, whereby the copper compound is discharged and prevented from adhering again.

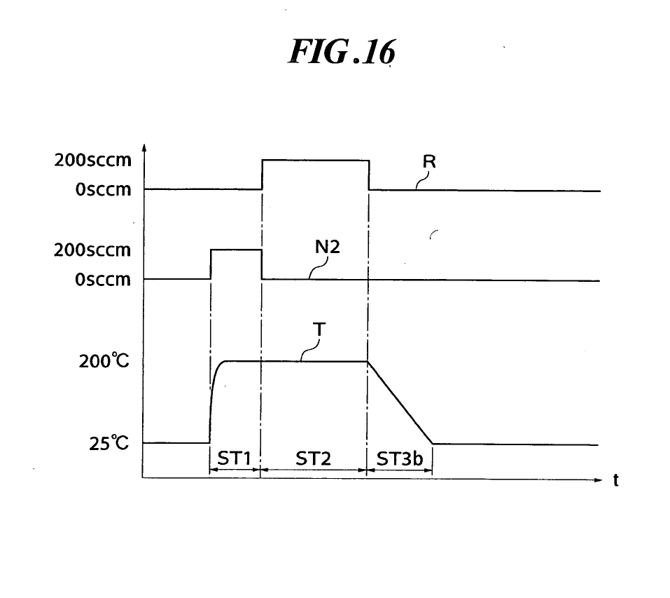

Referring next to FIG. 16, a substrate processing method according to an eleventh embodiment of the present invention is described. In this embodiment, the procedures from the step of preheating the substrate W (ST1) to the step of removing the oxide film (ST2) are the same as those in the tenth embodiment. When the processing time for removing the oxide film (ST2) is completed, the supply of the formic acid gas is stopped and the process chamber 10 is evacuated. Meanwhile, the substrate W is held on the substrate stage 12 with the heater therein kept on and the temperature of the substrate W is gradually lowered from the first prescribed temperature over a second prescribed period of time (ST3b). The second prescribed period of time is determined based on the thickness of the oxide film to be processed, and the processing time must be longer as the film thickness is larger. The second prescribed period of time may be 5 seconds or more, preferably at least 10 or 20 seconds and 10 minutes or less. Since the temperature of the substrate W is gradually lowered from the first prescribed temperature over the second prescribed period of time, thermal shock in the substrate W can be suppressed. The reaction to remove the copper compound remaining and adsorbed on the surface of the substrate W is the same as that in the tenth embodiment.

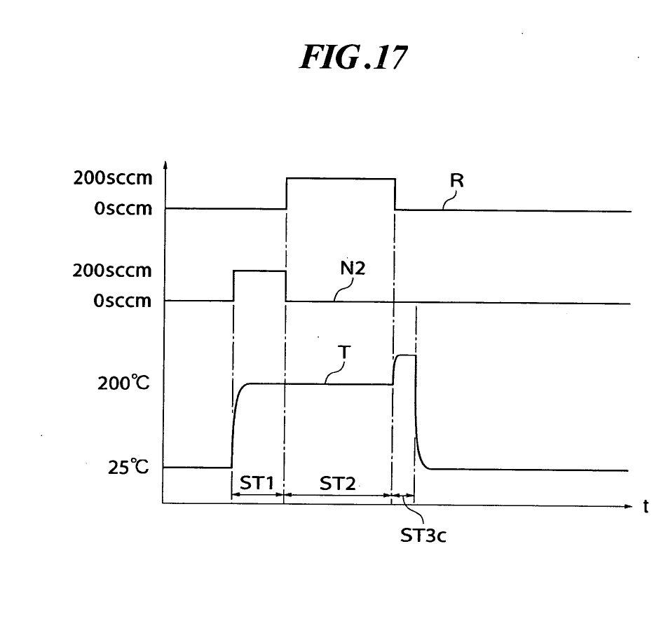

Referring next to FIG. 17, a substrate processing method according to a twelfth embodiment of the present invention is described. In this embodiment, the procedures from the step of preheating the substrate W (ST1) to the step of removing the oxide film (ST2) are the same as those in the tenth embodiment and the eleventh embodiment. When the processing time for removing the oxide film (ST2) is completed, the supply of the formic acid gas is stopped and the process chamber 10 is evacuated. Meanwhile, the substrate W is held on the substrate stage 12 with the heater therein kept on and the temperature of the substrate W is once raised to the second prescribed temperature to promote separation and removal of the copper compound (ST3c). The temperature may be raised by raising the temperature of the substrate stage 12 or using another heating source (such as a lamp). Since the temperature of the substrate W is once raised to the second prescribed temperature after the completion of the removal of the oxide film to promote separation and removal of the copper compound, the copper compound remaining and adsorbed on the surface of the substrate W can be removed within a short period of time and components with high separation temperature which cannot be removed at the temperature of the substrate W during the oxide film removing processing can be removed. After that, the substrate W is put down from the substrate stage 12, cooled and taken out of the process chamber 10, whereby the processing is completed.

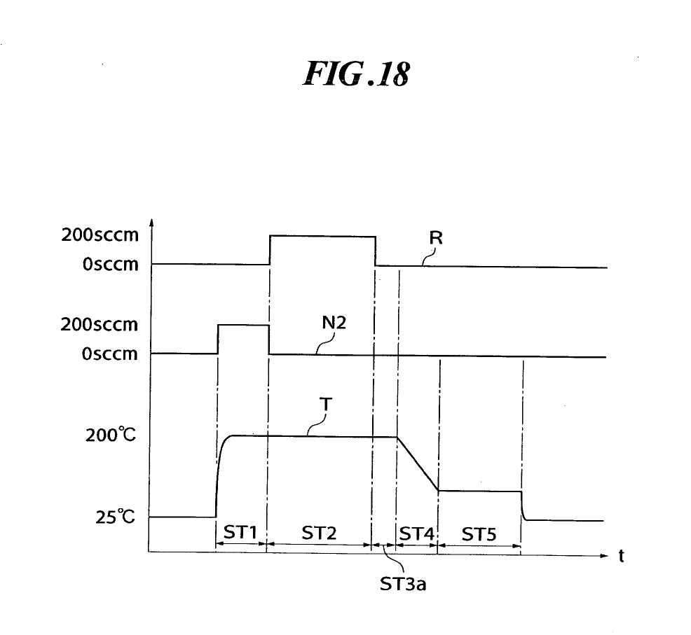

Referring next to FIG. 18, a substrate processing method according to a thirteenth embodiment of the present invention is described. In this embodiment, the procedures from the step of preheating the substrate W (ST1) through the step of removing the oxide film (ST2) to the step of controlling the temperature, such as maintaining the temperature of the substrate W at the first prescribed temperature, lowering the temperature of the substrate W gradually over the second prescribed period of time, or raising the temperature of the substrate W once to the second prescribed temperature (ST3x; x is one of a to c) are the same as those in the tenth embodiment to the twelfth embodiment. In FIG. 18, the temperature control in the tenth embodiment is shown as an example. After removing the copper compound remaining and adsorbed on the surface of the substrate W, the temperature of the substrate W is adjusted to the temperature (ST4) at which the next step is carried out. When the temperature of the substrate W reaches the temperature for the next step, the substrate W is transported to another process chamber 93 in which the next step is carried out (ST5). Therefore, preheating in the next step can be omitted.

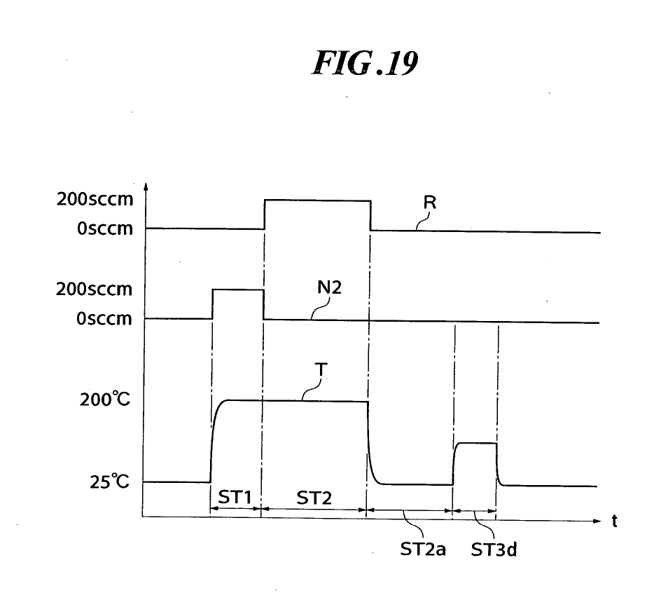

Referring next to FIG. 19, a substrate processing method according to a fourteenth embodiment of the present invention is described. In this embodiment, the procedures from the step of preheating the substrate W (ST1) to the step of removing the oxide film (ST2) are the same as those in the tenth embodiment to the thirteenth embodiment. When the processing time for removing the oxide film (ST2) is completed, the supply of the formic acid gas is stopped. Then, the substrate W is put down from the substrate stage 12 and transported from the process chamber 10 into the another process chamber 93 (ST2a). During the transportation, the temperature of the substrate W lowers. When the substrate W from which the oxide film has been removed is transported into the another process chamber 93, where evacuation to produce a vacuum and heating are carried out therein (ST3d). The another process chamber 93 may be a process chamber for the next step or may be the load lock chamber 11, or a preheating chamber (not shown) or transportation chamber (not shown) of a cluster apparatus. The heating of the substrate W in the another process chamber 93 may be carried out by heating from a stage or by lamp heating. The heating mechanism may be incorporated in the another process chamber 93 or in the transportation arm. Since it is only necessary that the heating temperature is equal to or higher than the temperature at which the copper compound is separated, it is not necessarily equal to the first prescribed temperature. By carrying out the processing for separating and removing the copper compound in the another process chamber 93, a decrease in throughput in the process chamber 10 can be prevented.

As describe above, by heating the substrate W under the above conditions in the process chamber 10 after removing the copper oxide on the surface of copper formed on the substrate W with formic acid gas, the compound scattered by etching can be removed. Such processing can be typically carried out with the substrate processing apparatus 101, 102, 105, or 106 described above.

1-37. (canceled)

38. A substrate processing apparatus for removing an oxide on a surface of a metal on a substrate, comprising:
a process chamber for keeping a substrate therein, the process chamber being gastight;
an evacuation control system for controlling the pressure in the process chamber; and
a process gas supply system for supplying a process gas containing a reducing organic compound to the process chamber;
the process gas supply system having:
an evaporator keeping liquid material of the reducing organic compound therein and having an evaporating liquid surface;
a process gas pipe for directing the process gas containing the reducing organic compound evaporated in the evaporator into the process chamber; and
a throttle element disposed in the process gas pipe for controlling the flow rate of the process gas to be supplied to the process chamber by adjusting the opening of the throttle element;
wherein the opening of the throttle element, the temperature in the evaporator, and the ratio between the evaporation area in the evaporator and the area to be processed of the substrate are so set that the pressure variation in the evaporator can be maintained within a prescribed range, so that an evaporation rate of the reducing organic compound necessary to generate a supply rate of the process gas required for the processing of the substrate can be continuously evaporated in the evaporator.

39. The substrate processing apparatus as recited in claim 38, wherein the process gas supply system controls the pressure in the evaporator at 80 to 100% of the saturated vapor pressure of the reducing organic compound in the environment in the evaporator.

40. The substrate processing apparatus as recited in claim 38, wherein the throttle element is at least one of a mass flow controller, an orifice, a capillary tube, and a throttle valve.

41. The substrate processing apparatus as recited in claim 38, further comprising a heating means for controlling the evaporator at a prescribed evaporation temperature.

42. The substrate processing apparatus as recited in claim 41, wherein the evaporation temperature is generally equal to room temperature.

43. The substrate processing apparatus as recited in claim 38, further comprising a heating means for heating the process gas pipe to a temperature which is equal to or higher than a temperature in the evaporator.

44. The substrate processing apparatus as recited in claim 38, further comprising a heating means for heating a secondary side section including the throttle element in the process gas pipe to a temperature which is equal to or higher than the temperature in the evaporator.

45. The substrate processing apparatus as recited in claim 38, wherein the reducing organic compound is a carboxylic acid.

46. The substrate processing apparatus as recited in claim 38, wherein the reducing organic compound is methanol or ethanol.

47. The substrate processing apparatus as recited in claim 38, wherein the reducing organic compound is formaldehyde or acetaldehyde.

48. The substrate processing apparatus as recited in claim 38, wherein the process chamber is connected to a vacuum transportation system for transporting the substrate in a gastight condition.

49. The substrate processing apparatus as recited in claim 48, wherein the process chamber is at least one of constituent elements of a composite processing apparatus including the vacuum transportation system.

50. The substrate processing apparatus as recited in claim 38, wherein the throttle element is secured to a part of the process chamber so that the throttle element can be heated by the process chamber.

51. The substrate processing apparatus as recited in claim 38, wherein the ratio between the evaporation area in the evaporator and the area to be processed of the substrate is at least 0.031.

52. The substrate processing apparatus as recited in claim 38, further comprising:
a substrate stage provided in the process chamber for placing the substrate thereon and heating the substrate;
a process gas supply port located at a position facing the substrate stage for supplying the process gas toward the substrate; and
a control device for performing control to raise the temperature of the substrate to a first prescribed temperature and supply the process gas to the substrate to remove an oxide on a surface of a metal on the substrate with the evaporated reducing organic compound material, and to hold the substrate in the process chamber and maintain the substrate at the first prescribed temperature for a first prescribed period of time after stopping the supply of the process gas.

53. A substrate processing method for removing an oxide on a surface of a metal on a substrate, comprising the steps of:
evaporating a reducing organic compound material in a liquid form to generate a process gas containing the reducing organic compound material;
adjusting the flow rate of the process gas by allowing the process gas to pass through a throttle element; and
supplying the process gas after the flow rate adjustment to the substrate;
wherein the flow rate of the process gas to be supplied to the substrate, the temperature of the reducing organic compound material in an evaporator, and the ratio between the evaporation area in the evaporator and the area to be processed of the substrate are so set that the pressure variation of the vapor of the reducing organic compound material before passing through the throttle element can be maintained within a prescribed range, so that an evaporation rate of the reducing organic compound necessary to generate a supply rate of the process gas to be supplied to the substrate can be continuously evaporated.

54. The substrate processing method as recited in claim 53, further comprising the step of:
removing an oxide generated on a metal portion on a surface of the substrate by carrying out reduction and etching of the oxide with the process gas supplied to the substrate.

55. A substrate processing apparatus for removing an oxide on a surface of a metal on a substrate, comprising:
a process chamber for keeping a substrate therein, the process chamber being gastight;
a substrate stage provided in the process chamber for placing the substrate thereon and heating the substrate;
a process gas supply port located at a position facing the substrate stage for supplying a process gas containing an evaporated reducing organic compound material toward the substrate;
an evacuation control means for evacuating gas in the process chamber to bring the pressure in the process chamber to a prescribed level; and
a process gas introduction means for introducing the process gas into the process chamber while controlling the flow rate of the process gas, wherein the temperature of the substrate is controlled at 140 to 250° C. so that an oxide on a surface of a metal on the substrate can be removed with the evaporated reducing organic compound material.

56. The substrate processing apparatus as recited in claim 55, wherein the temperature of the substrate is controlled at 160 to 210° C.

57. The substrate processing apparatus as recited in claim 55, wherein the process gas has a pressure of 40 Pa or higher.

58. The substrate processing apparatus as recited in claim 56, wherein the process gas has a pressure of 400 Pa or higher.

59. The substrate processing apparatus as recited in claim 55, wherein, when the process gas has a pressure in the range of 40 Pa or higher, the oxide on the surface of the metal on the substrate is removed under the condition that T and Y are in a range greater than T and Y represented by the following equation:
Y=(1.23×10⁵×exp(−0.0452T)+3634×exp(−0.0358T))/40
wherein T (° C.) represents the temperature of the substrate at which the oxide is removed, and Y (minutes/nm) represents the processing time in which the oxide with a unit thickness is removed.

60. The substrate processing apparatus as recited in claim 55, wherein, when the process gas has a pressure in the range of 400 Pa or higher, the oxide on the surface of the metal on the substrate is removed under the condition that T and Y are in a range greater than T and Y represented by the following equation:
Y=(202×exp(−0.0212T)+205×exp(−0.0229T))/40
wherein T (° C.) represents the temperature of the substrate at which the oxide is removed, and Y (minutes/nm) represents the processing time in which the oxide with a unit thickness is removed.

61. The substrate processing apparatus as recited in claim 55, wherein, when the process gas has a pressure in the range of 130 Pa or higher, a natural oxide film generated on the surface of the metal on the substrate is removed under the condition that T and Y are in a range greater than T and Y represented by the following equation:
Y=0.76×10⁵×exp(−0.0685T)
wherein T (° C.) represents the temperature of the substrate at which the natural oxide film is removed, and Y (minutes/nm) represents the processing time in which the natural oxide film with a unit thickness is removed.

62. The substrate processing apparatus as recited in claim 55, wherein, when the process gas has a pressure in the range of 400 Pa or higher, a natural oxide film generated on the surface of the metal on the substrate is removed under the condition that T and Y are in a range greater than T and Y represented by the following equation:
Y=1.32×10⁵×exp(−0.0739T)
wherein T (° C.) represents the temperature of the substrate at which the natural oxide film is removed, and Y (minutes/nm) represents the processing time in which the natural oxide film with a unit thickness is removed.

63. The substrate processing apparatus as recited in claim 55, wherein the substrate is a wafer for semiconductor.

64. The substrate processing apparatus as recited in claim 55, wherein the metal on the substrate is copper.

65. The substrate processing apparatus as recited in claim 55, wherein the reducing organic compound material is formic acid.

66. A substrate processing method, comprising the steps of:
removing an oxide generated on a metal portion on a surface of a substrate by heating the substrate kept in a process chamber to a first prescribed temperature and supplying an evaporated reducing organic compound material to the substrate; and
maintaining the substrate at the first prescribed temperature over a first prescribed period of time while holding the substrate in the process chamber after stopping the supply of the evaporated reducing organic compound material and the step of removing the oxide generated on the metal portion on the surface of the substrate.

67. The substrate processing method as recited in claim 66, wherein the first prescribed period of time is at least 3 seconds.

68. The substrate processing method as recited in claim 66, further comprising the step of:
evacuating the evaporated reducing organic compound material from the process chamber to raise the degree of vacuum in the process chamber after stopping the supply of the evaporated reducing organic compound material,
wherein the step of raising the degree of vacuum in the process chamber and the step of controlling the temperature of the substrate after stopping the supply of the evaporated reducing organic compound material are performed in parallel.

69. The substrate processing method as recited in claim 66, further comprising the steps of:
bringing the temperature of the substrate to a next step temperature as a temperature for a next step which is carried out in another process chamber other than the process chamber; and
transporting the substrate having reached the next step temperature into the another process chamber.

70. A control program to be installed in a computer connected to a substrate processing apparatus for causing the computer to control the substrate processing apparatus,
wherein the substrate processing apparatus uses a substrate processing method as recited in claim 66.

71. A substrate processing apparatus, comprising:
an process chamber for keeping a substrate therein, the process chamber being gastight; and
a control device including a computer in which the control program as recited in claim 70 is installed.

72. A substrate processing method, comprising the steps of:
removing an oxide generated on a metal portion on a surface of a substrate by heating the substrate kept in a process chamber to a first prescribed temperature and supplying an evaporated reducing organic compound material to the substrate; and
lowering gradually the temperature of the substrate from the first prescribed temperature over a second prescribed period of time while holding the substrate in the process chamber after stopping the supply of the evaporated reducing organic compound material and the step of removing the oxide generated on the metal portion on the surface of the substrate.

73. The substrate processing method as recited in claim 72, wherein the second prescribed period of time is 5 seconds or longer and 10 minutes or shorter.

74. The substrate processing method as recited in claim 72, further comprising the step of:
evacuating the evaporated reducing organic compound material from the process chamber to raise the degree of vacuum in the process chamber after stopping the supply of the evaporated reducing organic compound material,
wherein the step of raising the degree of vacuum in the process chamber and the step of controlling the temperature of the substrate after stopping the supply of the evaporated reducing organic compound material are performed in parallel.

75. The substrate processing method as recited in claim 72, further comprising the steps of:
bringing the temperature of the substrate to a next step temperature as a temperature for a next step which is carried out in another process chamber other than the process chamber; and
transporting the substrate having reached the next step temperature into the another process chamber.

76. A control program to be installed in a computer connected to a substrate processing apparatus for causing the computer to control the substrate processing apparatus,
wherein the substrate processing apparatus uses a substrate processing method as recited in claim 72.

77. A substrate processing apparatus, comprising:
an process chamber for keeping a substrate therein, the process chamber being gastight; and
a control device including a computer in which the control program as recited in claim 76 is installed.

78. A substrate processing method, comprising the steps of:
removing an oxide generated on a metal portion on a surface of a substrate by heating the substrate kept in a process chamber to a first prescribed temperature and supplying an evaporated reducing organic compound material to the substrate; and
raising the temperature of the substrate to a second prescribed temperature which is higher than the first prescribed temperature while holding the substrate in the process chamber after stopping the supply of the evaporated reducing organic compound material and the step of removing the oxide generated on the metal portion on the surface of the substrate.

79. The substrate processing method as recited in claim 78, further comprising the step of:
evacuating the evaporated reducing organic compound material from the process chamber to raise the degree of vacuum in the process chamber after stopping the supply of the evaporated reducing organic compound material,
wherein the step of raising the degree of vacuum in the process chamber and the step of controlling the temperature of the substrate after stopping the supply of the evaporated reducing organic compound material are performed in parallel.

80. The substrate processing method as recited in claim 78, further comprising the steps of:
bringing the temperature of the substrate to a next step temperature as a temperature for a next step which is carried out in another process chamber other than the process chamber; and
transporting the substrate having reached the next step temperature into the another process chamber.

81. A control program to be installed in a computer connected to a substrate processing apparatus for causing the computer to control the substrate processing apparatus,
wherein the substrate processing apparatus uses a substrate processing method as recited in claim 78.

82. A substrate processing apparatus, comprising:
an process chamber for keeping a substrate therein, the process chamber being gastight; and
a control device including a computer in which the control program as recited in claim 81 is installed.
